(19) United States
(12) Patent Application Publication
(10) Pub. No.: US 2018/0141836 A1
(43) Pub. Date: May 24, 2018

(54) ELECTROCHEMICAL REMOVAL OF SULFIDE SPECIES AND PHOSPHORUS SPECIES

(71) Applicants: Bo Hu, North Oaks, MN (US); Hongjian Lin, St. Paul, MN (US)

(72) Inventors: Bo Hu, North Oaks, MN (US); Hongjian Lin, St. Paul, MN (US)

(21) Appl. No.: 15/814,889

(22) Filed: Nov. 16, 2017

Related U.S. Application Data
(60) Provisional application No. 62/422,998, filed on Nov. 16, 2016.

(51) Int. Cl. C02F 1/461; C02F 3/00; C02F 11/00

(52) U.S. Cl. CPC C02F 1/46109; C02F 3/005; C02F 2101/101; C02F 2001/46133; C02F 11/006

(57) ABSTRACT

According to various embodiments a system includes a housing. A chamber is disposed within the housing and receives a working fluid. The working fluid includes at least one of one or more sulfide species and one or more phosphorous species. In the system a first anode and a first cathode are each at least partially disposed within the chamber. At least one of the first anode and the first cathode are formed from at least one of: low carbon steel, stainless steel, copper, plain carbon cloth, and one or more mixed metal oxides. At least a first one of the one or more sulfide species and the one or more phosphorous species is electrochemically converted at the first anode or the first cathode to at least one first reaction product. The first reaction product is removable from the working fluid through a separation apparatus.

### CROSS-REFERENCE TO RELATED APPLICATION

This application claims the benefit of priority to U.S. Provisional Patent Application Ser. No. 62/422,998 entitled “Electrochemical Removal of Sulfide Species and Phosphorus Species,” filed Nov. 16, 2016, the disclosure of which is incorporated herein by reference in its entirety.

### STATEMENT OF GOVERNMENT SUPPORT

This invention was made with Government support under [identify the contract] awarded by [identify the Federal agency]. The U.S. Government has certain rights in this invention.

### BACKGROUND

Sulfide species or phosphorous species, or both, can be present in a wide range of working fluids. For example, sulfide species, such as hydrogen sulfide (H₂S) or its aqueous or ionized forms, can be present in agricultural, residential and industrial processing waste streams in various industries. Sulfide species can be chemically corrosive, which can damage equipment, such as devices used for biogas utilization, sewerage, piping, and anaerobic digesters. H₂S is a health hazard to exposed humans and animals, and is a source of odor. Phosphorous species (P), mainly in the form of phosphates, can be present in wastewater and agricultural runoff. When P enters inland lakes above a threshold level, it can contribute to the occurrence of eutrophication that deteriorates the air or the water environment, or both. For these reasons, often desirable to remove sulfide species or phosphate species, or both, from working fluids.

### SUMMARY OF THE INVENTION

The present disclosure describes systems and methods for removing one or both of sulfide species from a working fluid. In an example, a system is described for removing one or more sulfide species or one or more phosphorous species, or both. In an example, the system includes a housing with a chamber disposed at least partially within the housing. The chamber can receive a working fluid that includes at least one of one or more sulfide species and one or more phosphorous species. A first anode and a first cathode each can be at least partially disposed within the chamber. In an example, at least one of the first anode and the first cathode are formed from at least one of: low carbon steel, stainless steel, copper, carbon cloth, and one or more mixed metal oxides. At least the one or more sulfide species and the one or more phosphorous species is electrochemically converted at the first anode or the first cathode to at least one first reaction product, wherein the first reaction product is removable from the working fluid, such as with a separation apparatus.

In an example, a method is described for removing at least one of one or more sulfide species or one or more phosphorous species from a working fluid. In an example, the method includes contacting the working fluid with at least one of a first anode and a first cathode and applying a voltage across the first anode and the first cathode. This results in the electrochemical conversion of at least a first one of the one or more sulfide species and the one or more phosphorous species to a reaction product. The reaction product may then be separated from the working fluid to provide a purified working fluid.

The present inventors have recognized, among other things, that a problem to be solved can include that conventional methods of removing hydrogen sulfide from a gas-phase working fluid have required concentrating the hydrogen sulfide in the gas phase in order to transfer sufficient amounts of the hydrogen sulfide to an electrolyte. The subject matter described herein provides a solution to this problem because the systems and methods described herein can allow sulfide species to be removed directly from an aqueous media, which in turn reduces the concentration of volatized hydrogen sulfide in the gas phase.

The present inventors have recognized, among other things, that a problem to be solved can include the use of an ion-exchange membrane between an anode and a cathode in previous methods of electrochemical removal of sulfide species, which adds to the capital and maintenance costs. The subject matter described herein provides a solution to this problem because the systems and methods described herein do not require ion-exchange membrane between an anode and a cathode. The present inventors believe that this is so because when the sulfide species is being removed from an aqueous media, the cathode shows low selectivity with respect to sulfate or sulfur reduction to sulfide such that the need to discourage sulfate or sulfur reacting with the cathode is reduced or eliminated.

The present inventors have recognized, among other things, that a problem to be solved can include the requirement of the formation of an anodic biofilm to catalyze oxidation. The subject matter described herein provides a solution to this problem because systems and methods described herein do not absolutely require the formation of an anodic biofilm. The present inventors believe this is because the electrode materials alone have good catalytic effect on sulfide oxidation. However, an anodic biofilm can optionally be used to further catalyze the oxidation reaction. According to some further embodiments, the electrode materials that show favorable oxidation of the sulfide species are less expensive than other materials that are commonly used as electrodes such as platinum.

The present inventors have recognized, among other things, that a problem to be solved can include having to implement a sulfide or phosphorous system at an elevated temperature. The subject matter described herein does not absolutely require the methods or systems to be operated above ambient temperatures. This is because of the electrode materials that are used, which allow, the system and method can be implemented in ambient conditions without substantial heating or pressurization. This can result in an overall lower operating cost of the systems and methods.

### BRIEF DESCRIPTION OF THE FIGURES

The drawings illustrate generally, by way of example, but not by way of limitation, various examples discussed in the present document. In the drawings, which are not necessarily drawn to scale, like numerals describe substantially similar components throughout the several views. Like numerals having different letter suffixes represent different instances of substantially similar components.

FIG. 1 is a schematic diagram of system for the removal of sulfide and phosphorous species.

FIG. 2 is a schematic diagram showing different pathways for sulfide removal using the system of FIG. 1.

FIG. 3A is a plot of H₂S concentration in a 2 mM Na₂S synthetic media over time in an electrochemical oxidation system.

FIG. 3B is a plot of H₂S concentration in a 10 mM Na₂S synthetic electrolyte media solution over time at various locations in an electrochemical oxidation system.

FIGS. 4A-4D are cyclic voltammograms showing results using different electrode materials.

FIGS. 5A-5F are plots of headspace H₂S levels generated with synthetic media during electrochemical oxidation for various electrode materials, various media concentrations, and various temperatures.

FIGS. 6A-6C are bar graphs of the sulfide and sulfate concentrations in final synthetic media after electrochemical oxidation with various electrode materials and various media concentrations.

FIG. 7A is a graph showing the current in the electrolytic cells at various applied voltages, combinations of electrodes, and temperatures.

FIGS. 7B and 7C are bar graphs of the resulting biogas composition after electrochemical oxidation at 3V with various electrode combinations and temperatures in mL of each component (FIG. 7B) and percentage of the total biogas (FIG. 7C).

FIG. 7D is a bar graph of the hydrogen sulfide concentration in the biogas after electrochemical oxidation at 3V with various electrode combinations and temperatures.

FIGS. 8A and 8B are plots of electrochemical impedance spectroscopy of different electrode combinations and at different applied voltages.

FIG. 9 is a bar graph of cumulated methane yields in dairy manure anaerobic digesters for various electrode combinations and applied voltages.

FIG. 10A is a bar graph of the current through the anode and cathode of a plurality of comparable reactors at various applied voltages.

FIG. 10B is a bar graph of biogas generated by the same example reactors and at the same various applied voltages as in FIG. 10A.

FIG. 10C is a plot of the total phosphorous level in the same example reactors and at the same various applied voltages as in FIGS. 10A and 10B.

FIG. 10D is a plot of the total phosphorous removed from the same example reactors and at the same various applied voltages as in FIGS. 10A-10C.

FIG. 10E is a plot of the reactive phosphorous level in the same example reactors and at the same various applied voltages as in FIGS. 10A-10D.

FIG. 10F is a plot of the reactive phosphorous removed from the same example reactors and at the same various applied voltages as in FIGS. 10A-10E.

FIG. 10G is a scatter plot of the chemical oxygen demand in the same example reactors and at the same various applied voltages as in FIGS. 10A-10F.

FIG. 10H is a scatter plot of the total nitrogen level in the same example reactors and at the same various applied voltages as in FIGS. 10A-10G.

FIGS. 11A-11D show various characteristics of reactor contents, inoculated sewage and sewage.

FIGS. 12A-12D show concentrations of influents and effluents of simulated microbial electrochemical septic tanks (“MESTs”) and septic tanks (“STs”).

FIG. 13A is a bar graph of the sulfide concentration in a wastewater sample before and after anaerobic storage and a before and after electrochemical treatment.

FIG. 13B is a bar graph of the hydrogen sulfide level in headspace gas above the wastewater sample of FIG. 13A before and after the anaerobic digestion and before and after the electrochemical treatment.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y. or about Z.” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B. or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the invention, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

In this disclosure, systems and methods for the removal of sulfide species or phosphorus species, or both, form a working fluid are presented. In some examples, the term “sulfide species,” as used herein, can refer to a species that includes one or more atoms of sulfur (S) having an oxidation state of −2, such as hydrogen sulfide (H₂S), sulfide ions (S²⁻), or bisulfide ions (HS⁻), also sometimes referred to as sulfanide ions or “hydrogen sulfide(−1)”) or any species that includes one or more atoms of sulfur having a different oxidation state, but that is known to regular convert to a compound comprising sulfur with the oxidation state of −2, and in particular to compounds that convert to H₂S²⁻. S²⁻, or HS⁻ in the aqueous phase or to H₂S in the gaseous phase.

In some examples, the term “phosphorous species.” as used herein, can refer to phosphorous of different oxidation states

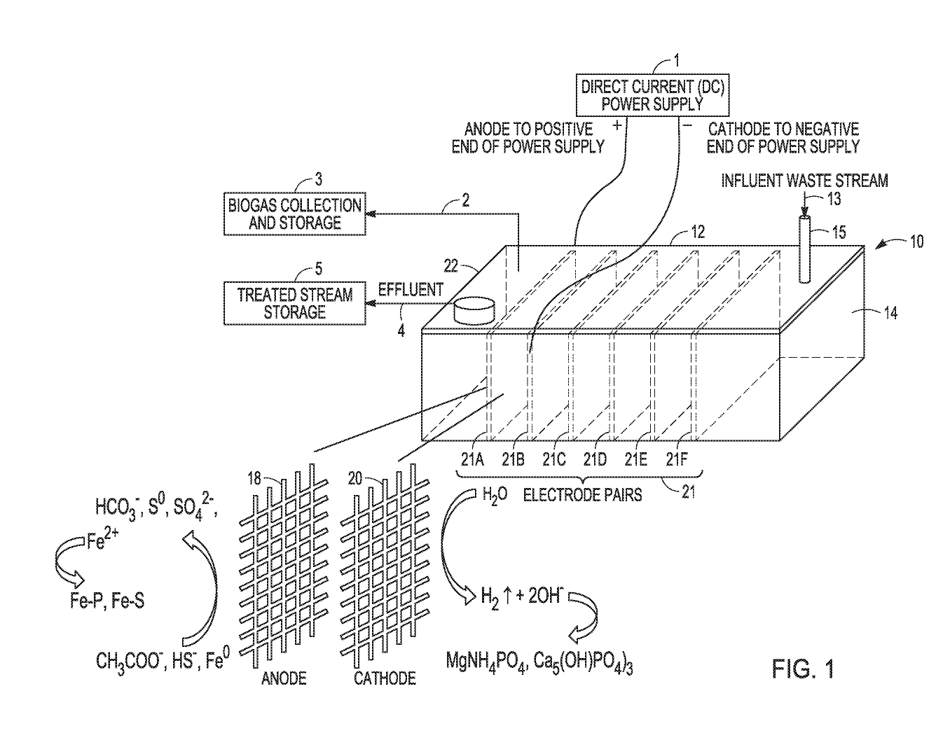

FIG. 1 is a schematic diagram of an example system 10. In an example, the system 10 includes a power supply 1 a biogas collection and storage device 3, a treated stream storage device 5, a effluent stream, a treated stream 4, and a housing 12. A chamber 14 can be at least partially defined within housing 12. The chamber 14 receives a working fluid 13, for example through an inlet 16. The working fluid 13 includes one or more species that are to be at least partially removed from the working fluid 13 by the system 10 to provide a purified working fluid 15. In an example, the one or more species to be removed by the system 10 includes at least one of one or more sulfide species and one or more phosphorous species, i.e., the working fluid 13 can include one or more sulfide species, one or more phosphorous species, or both one or more sulfide species and one or more phosphorous species. In some examples, the term “purified working fluid” can refer to the purified working fluid 15 being purified with respect to the content of one or more sulfide species, one or more phosphorous species, or both one or more sulfide species and one or more phosphorous species that was present in the working fluid 13 that is fed to the system 10.

System 10 includes a number of anode and cathode pairs 21A-21F. In an example, a first anode 18A and a first cathode 20A are each at least partially disposed within chamber 14. As described further herein, in an example, at least a first one of the one or more sulfide species and the one or more phosphorous species is electrochemically converted at first anode 18A or first cathode 20A to at least one first reaction product that can be more easily removed from the working fluid 13. In an example, the system 10 further includes an outlet 22, which can provide for withdrawal of the working fluid 13 (which includes the at least one first reaction product formed by converting the one or more sulfide species or the one or more phosphorous species, or both) from the chamber 14. The working fluid 13 can be transferred from the outlet 22 to an optional separation apparatus 24 that can separate at least a portion of the at least one first reaction product from the working fluid 13 to provide the purified working fluid 15.

The ability of system 10 to convert the sulfide or phosphorus species can depend on the material or materials that are used to make the respective anode or cathode. First anode 18A and first cathode 20A can be formed from a number of electrode materials. Examples of suitable electrode materials include low carbon steel, stainless steel, copper, carbon cloth, and one or more mixed metal oxides. In an example, one or both of the first anode 18A and the first cathode 20A can be made from a stainless steel having a grade as rated by the American Iron and Steel Institute (AISI), including, but not limited to, AISI 304 stainless steel, AISI 316 stainless steel, AISI 430 stainless steel, or a combination thereof. In an example, one or both of the first anode 18A and the first cathode 20A can be made from copper. A suitable copper is C110 copper, which is a 99.9% pure copper as rated according to the International Annealed Copper Standard. In some examples, the first anode 18A and the first cathode 20A are made from the same material. In some examples, the first anode 18A and the first cathode 20A are made from different materials. Two different materials have been selected for evaluation. The first type of materials is sacrificing anodes, including low carbon steel, copper, and potentially other materials. The product from release of metal ions and formation of metal oxides at low applied voltage (<1 V) will react with sulfide in solution and produce metal sulfide of low solubility product constants. The second type of materials is non-sacrificing anodes that show good catalysis on sulfide oxidation. Studies from other groups have proved the efficiency of mixed metal oxides (MMOs) for sulfide removal in sewage storage and treatment. Our research proved the catalysis of various stainless steels (AISI 304, AISI 316, and AISI 430) and carbon cloth on sulfide oxidation to higher oxidation states at ambient conditions of temperature and pressure and close-to-neutral pH, while these materials are more available and the manufacturing cost is much less than that of MMOs.

In some examples of system 10, a microbial biofilm is disposed on an external surface of first anode 18A. The microbial biofilm can help to catalyze certain electrochemical reactions. The microbial biofilm can be disposed over a differing extent of first anode 18A. For example the microbial biofilm can be disposed over at least about 1% of the total surface area of one or more external surfaces of first anode 18A (also referred to as the “anode external surfaces”), such as at least about 5%, at least about 10%, at least about 15%, at least about 30%, or more of the total surface area of the one or more anode external surfaces. In an example, the microbial biofilm is disposed on from about 5% to about 100%, such as from about 10% to about 25% of the total surface area of the one or more anode external surfaces. In some examples, the microbial biofilm is disposed on at least about 1%, 5, 10, 15, 20, 25, 30, 35, 40, 45, 50, 55, 60, 65, 70, 75, 80, 85, 90, or 95% of the total surface area of the anode external surfaces first anode 18A. In some examples, the microbial biofilm is disposed on no more than about 5%, 10, 15, 20, 25, 30, 35, 40, 45, 50, 55, 60, 65, 70, 75, 80, 85, 90, 95, 96, 97, 98, 99, 99.9, 99.99, 99.999, or 100% of the total surface area of the anode external surfaces. The extent to which the microbial biofilm is dispensed over first anode 18A can be selected based on many factors, including, but not limited to, a desired catalytic effect of system 10.

As shown in FIG. 1, the first anode 18A and the first cathode 20A can form a first electrode pair 17A. The first electrode pair 17A is formed by spacing the first anode 18A and the first cathode 20A by a first predetermined distance and positioning the first electrode pair 17A in the chamber 14 so that the working fluid 13 will contact one or both of the first anode 18A and the first cathode 20A. In addition to the first pair 17A, the system 10 can include one or more additional electrode pairs 17B, 17C, 17D, 17E (collectively referred to herein as “electrode pairs 17” or “electrode pair 17”), with each electrode pair 17 including a corresponding anode 18 and a corresponding cathode 20. For example, the system 10 can include a second electrode pair 17B of a second anode 18B a second cathode 20B spaced by a second predetermined distance, which can be the same as the predetermined distance between the first anode 18A and the first cathode 20A. In an example, the system 10 can include a third electrode pair 17C (in addition to the first and second electrode pairs 17A and 17B) that includes a third anode 18C and a third cathode 20C spaced by a third predetermined distance, which can be the same or different from one or both of the first and second predetermined distances for the first and second electrode pairs 17A, 17B. In further examples, the system 10 can include a fourth electrode pair 17D, a fifth electrode pair 17E, a sixth electrode pair 17F, and so on, with each successive electrode pair 17 including a corresponding anode 18D. 18E. 18F and a corresponding cathode 20D, 20E, 20F, respectively. In some examples, each of the anodes 18B, 18C, 18D, 18E, 18F and the cathodes 20B, 20C, 20D, 20E, 20F can be similar or identical to the first anode 18A and the first cathode 20A, respectively. For example, at each electrode pair 17, at least a second one of the one or more sulfide species and the one or more phosphorous species can be electrochemically converted at the corresponding anode 18 or the corresponding cathode 20 to at least one second reaction product that is removable from the working fluid 13. In some examples, the material of one or more of the additional anodes 18 can be formed from any of the same materials described above for the first anode 18A and the material of the one or more additional cathodes 20 can be formed from any of the same materials described above for the first cathode 20. In an example, the first anode 18A can be made from the same materials as one or more, and in some examples all of, the additional anodes 18B, 18C. 18D. 18E, 18F that may be present in the system 10. In an example, the first anode 18A can be made from a different material as one or more, and in some examples all of, the additional anodes 18B, 18C, 18D, 18E, 18F that may be present in the system 10. In an example, the first cathode 20A can be made from the same materials as one or more, and in some examples all of, the additional cathodes 20B, 20C, 20D, 20E, 20F that may be present in the system 10. In an example, the first cathode 20A can be made from a different materials as one or more, and in some examples all of, the additional cathodes 20B, 20C, 20D, 20E, 20F that may be present in the system 10. For each electrode pair 17, the corresponding anode 18 can be made from the same material as the corresponding cathode 20 (e.g., for the second electrode pair 17B, the second anode 18B can be made from the same material as the second cathode 20B) or a different material (e.g., for the second electrode pair 17B, the second anode 18B can be made from a different material from that of the second cathode 20B).

Similar to first anode 18A, in some examples, one or more of the one or more additional anodes 18B, 18C, 18D, 18E. 18F can include a microbial biofilm disposed on one or more external surfaces in order to help to catalyze certain electrochemical reactions. In some examples, the microbial biofilm of each anode 18 (if present) can be disposed over the same portion of the total surface area as with the first anode 18A, as described above, or a different portion of the total surface area. In some examples, the microbial biofilm can be formed using the same microbe or microbes as that used on the first anode 18A, or with a different microbe or microbes, e.g., to catalyze different reactions at different electrode pairs XX. The extent to which a microbial biofilm may be disposed and the microbe or microbes used to form the biofilm on a particular anode 18 can be selected based on the desired catalytic effect of a particular electrode pair 17 and for the system 10 as a whole.

System 10 includes an electrolyte media 19 dispensed within chamber 14. The electrolyte media provides a pathway for a net ion flow between an anode 18 and a cathode 20 of a particular electrode pair 17. The electrolyte media may be between the anode and the cathode. In many examples, a working fluid 13 to be treated, such as wastewater, has conductivity of greater than 0.5 mS/cm to employ the technology. In an example, a conductivity of the electrolyte media can range from about 0.5 mS/cm to about 2 mS/cm, or from about 1 mS/cm to about 1.5 mS/cm, or less than about, equal to about, or greater than about 0.6 mS/cm, 0.7, 0.8, 0.9, 1, 1.1, 1.2, 1.3, 1.4, 1.5, 1.6, 1.7, 1.8, or 1.9 mS/cm, an electrolyte media 19 may only be used if an electrical conductivity of the working fluid 13 being treated is below a threshold, such as below about −0.5 mS/cm.

System 10 can further include a non-activated electrode (not shown in FIG. 1). The non-activated electrode can be disposed alongside electrode pairs 17. The non-activated electrode is not hooked up to a circuit and cannot receive a voltage as electrode pairs 17 can. As discussed further herein, the non-active electrode can aid in removal of the sulfide species or the phosphorous species, or both. The material that the non-active electrode is formed from can vary. For example, the non-active electrode can be formed from at least one of tin oxide and lead oxide. The non-active electrode material can be coated on a substrate disposed alongside electrode pairs 17. The substrate can be formed from many different materials including, but not limited to, titanium and boron-doped diamond.

As discussed herein, the working fluid can contain either or both of a first sulfide species and first phosphorus species, either of which can be hazardous to health. The exact type of sulfide species that is present can vary, but examples can include hydrogen sulfide, bisulfide, or sulfide. The amount of the sulfide species in the working fluid can be up to 10 mmol/L as being tested, but a higher concentration can also be treated. Similarly, the amount of the phosphorous species in the working fluid can range from 5 to 1000 mg-P/L of the working fluid.

The working fluid 13 in system 10 can be one of many different types of working fluids. In some examples, the working fluid 13 is organic waste including, but not limited to, animal manure, sewage, municipal wastewater, wastewater treatment plant sludge, food processing wastewater, an organic fraction of municipal solid waste, or a combination thereof. Within the working fluid 13, the at least one of the one or more sulfide species and the one or more phosphorous species can be in an aqueous phase and can be removed while in the aqueous phase.

In addition to organic waste, the working fluid 13 can take on additional forms. For example, the working fluid 13 can include a biogas that includes carbon dioxide and methane gas produced from anaerobic degradation or anaerobic digestion, and gaseous hydrogen sulfide emitted from liquid. The working fluid 13 can also be a combination of the biogas and organic waste.

In operation, the working fluid 13 is contacted with at least one of the first anode 18A and the first cathode 20A. A voltage is then applied across the first anode 18A and the first cathode 20A to drive the conversion of the one or more sulfide species or the one or more phosphorous species, or both, to the first reaction product. In an example, the voltage applied across the anode 18A and the cathode 20A can range from about 0.2 V to about 5 V, such as from about 1 V to about 3 V or less than about, equal to about, or greater than about 0.5 V, 1, 1.5 2, 2.5, 3, 3.5, 4, or 4.5 V. In an example, the voltage is applied for a predetermined amount of time. For example, the voltage can be applied to first anode 18A and first cathode 20A for a variable time period. In another example, a voltage is applied for 15 minutes every day for continuous 35 days. The time period can range from about 4 hours to about 200 days or from about 1 day to about 70 days or from about 20 days to about 70 days, or less than about, equal to about, or greater than about 1 day, 10, 20, 30, 40, 50, 60, 70, 80, 90, 1000, 110, 120, 130, 140, 150, 160, 170, 180, or 190 days. The exact time can be a function of the removal capabilities of system 10 or the desired amount of sulfide species or phosphorous species to be removed. During the removal period, e.g., when the voltage is applied across the anode 18A and the cathode 20A, a temperature of the working fluid 13 is maintained at from about 15° C. to about 35° C., or from about 15° C. to about 25° C., or less than about, equal to about, or greater than about 16° C., 17, 18, 19, 20, 21, 22, 23, 24, 25, 26, 27, 28, or 29° C.

In an example, the voltage is applied at a substantially constant voltage during the predetermined amount of time. In an example, the voltage can be applied in a variable manner during the predetermined amount of time. In an example, the exact voltage applied and time that it is applied can vary depending on the desired amount of sulfide species or phosphorous species to be removed from the working fluid 13. In some examples, the voltage applied across any additional electrode pairs 17 that may be present in the system 10 can be the same as the voltage applied across the first electrode pair 17A with respect to one or more of, and in some examples all of, the specific voltage applied, the predetermined time that the voltage is applied, and whether the voltage is a constant or a variable voltage.

Depending on the temperature of the working fluid 13 and the voltage applied, the total amount of energy consumed by system 10 in order to remove at least one of the one or more sulfide species and the one or more phosphorous species can range from about 0.2 kWh/m³ of the working fluid to about 40 kWh/m³ of the working fluid or from about 0.2 kWh/m³ of the working fluid to about 10 kWh/m³, or less than about, equal to about, or greater than about 0.5 kWh/m³, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, or 39.5 kWh/m³.

In some examples, the one or more sulfide species can be converted into a reaction product that comprises one or more of: a disulfide, a polysulfide, elemental sulfur, a polythiosulfite, a thiosulfate, a sulfite, a sulfate, or a mixture thereof. In an example, the one or more phosphorous species can be converted into a solid reaction product comprising one or more of: an iron phosphate, a calcium phosphate, or a struvite. These reaction products described above are generally easier to separate from the working fluid 13, allowing for separation to provide the purified working fluid 15. These treated working fluid 15 described above tend to pose a relatively lower health hazard compared to the unreacted working fluid 13 containing sulfide species or phosphorous species.

After the voltage has been applied, the working fluid 13 can be fed to the separation apparatus 24 from the chamber 14 via the outlet 22. In an example, the outlet 22 includes a valve. Examples of apparatuses that can be part of the separation apparatus 24 include, but are not limited to filtration tanks, a drum screen, an inclined screen, a conveyor screen, a vibrating/rotating screen, a centrifuge, a hydrocyclone, a dryer, a sedimentation tank, a floatation tank, or a waste storage tank. However, it is not necessary to further treat the purified working fluid 15 with an additional separation step, if the electrochemical treatment is employed in waste storage systems.

System 10 can be a stand-alone system or a modular system that can be incorporated into many different systems. For example system 10 can be a component of a centralized sewage system or a subsurface sewage treatment system. In this manner, system 10 can be used to help remove one or both of sulfide species and phosphorus species from sewage. The sewage system can be used for human or animal waste. System 10 can also be used in biological applications such as in an anaerobic digester system and a biogas generation system.

There are many types of anaerobic digester systems that system 10 can be incorporated into including a continuously stirred tank reactor, a plug flow reactor, a batch reactor, a semi-batch reactor, an anaerobic sequencing batch reactor, an upflow anaerobic sludge blanket reactor, an anaerobic membrane bioreactor, or an expanded granular sludge blanket reactor.

In other examples, system 10 can be at least partially disposed in a well a tunnel or an agricultural silo. Thus system 10 can remove sulfide species or phosphoru species, or both, from runoff. This can be particularly useful in high volume agricultural regions where animal wastes containing sulfides are stored before land application, and runoff from fields may contain levels of animal waste containing phosphorus species.

In still other examples, system 10 can be located at least partially within an aqueous environment. For example, system 10 can be located in a stream or tributary to remove sulfide species or phosphorous species, or both, from the water before the respective species can enter a larger body of water.

The operation of system 10 can be better understood as explained in conjunction with a method for removing at least one of one or more sulfide species or one or more phosphorous species from a working fluid 13. The method includes contacting the working fluid 13 with at least one of first anode 18A and first cathode 20A. As described herein, a voltage is applied across first anode 18A and first cathode 20A. Application of the voltage results in electrically converting at least a first one of the one or more sulfide species and the one or more phosphorous species to a reaction product. The reaction product is then separated from the working fluid 13 to provide a substantially purified working fluid 15.

Without intending to be limited to any particular theory, the inventors believe that the conversion of the sulfide species into one or more reaction products can result from a series of reactions and factors as described below. One benefit of the system 10 and methods described herein is that sulfide species can be removed in the aqueous phase. H₂S concentration in gas phase, or its partial pressure, is pH sensitive because of its nature of acid dissociation/association. When at equilibrium, the following relationships hold true:

$$\begin{matrix}{P}_{g} = \frac{{[ {H}_{2} S ]}_{t}}{{K}_{H}} & Eq . ( 1 ) \\ ToT ( Sulfide ) = {[ {H}_{2} S ]}_{t} + [ {HS}^{-} ] & Eq . ( 2 ) \\ pH = pKa + log 10 ( \frac{[ {HS}^{-} ]}{{[ {H}_{2} S ]}_{t}} ) , & Eq . ( 3 )\end{matrix}$$

where P_{g} is partial pressure of H₂S in gas phase. [H₂S]₁ is the hydrogen sulfide concentration in aqueous phase, K_{H} is the Henry's law constant of hydrogen sulfide, [HS⁻] is the bisulfide concentration in aqueous phase, ToT(Sulfide) is the total concentration of aqueous sulfide, and pKₐ is the dissociation constant (ca. 7.0) of hydrogen sulfide in water. H₂S(g), or equivalently, partial pressure of H₂S in gas phase (P₈), is derived from Eqs. (1)-(3) as follows:

$${P}_{g} = \frac{ToT ( Sulfide )}{{K}_{H} \times ( 1 + {10}^{( p H - pKa )} )} . \qquad Eq . ( 4 )$$

From Eq. (4), it can be seen that an increased pH suppresses H₂S volatilization and reduces its concentration in gas phase at equilibrium. Since cathodic reaction in aqueous media is dictated by hydrogen evolution reaction from proton/water (Eq. (5)), the electrochemically based process elevates the overall pH and decreases the portion of protonated sulfide species:

2H₂O+2e⁻=H₂↑T+2OH⁻ E^{o′}=−0.414 V vs. SHE, pH=7 Eq. (5).

Meanwhile, anodic reactions, catalyzed either by anode biofilm or the corresponding electrode materials, may proceed as follows to oxidize sulfide species to elemental sulfur and further to sulfate:

S(s)+2e⁻+H⁺-->HS⁻ E^{o′}=−0.271 V vs. SHE, pH=7 Eq. (6)

S(s)+2e⁻-->S²⁻ E^{o′}=−0.476 V vs. SHE. pH=7 Eq. (7)

SO₄²⁻+8e⁻+9H⁺-->HS⁻+4H₂O E^{o′}=−0.213 V vs. SHE, pH=7 Eq. (8)

SO₄²⁻+6e⁻+8H⁺-->S(s)+4H₂O E^{o′}=−0.476 V vs. SHE. pH=7 Eq. (9).

However, the presence of activation over potential, and the effectiveness of catalyst for sulfide/sulfur oxidation, would kinetically limit the rate of the oxidation reactions. The rate of electron transfer at the anode interface can be described by the simplified Butler-Volmer equation:

$$j = {j}_{oA} {e}^{\frac{n F {α}_{A} F ( {E}_{A} - {E}_{A}^{o ′} )}{RT} ,} \qquad Eq . ( 10 )$$

where j is the electrical current density, j_{oA} is the exchange current density of anode, α_{A} is the transfer coefficient of the anodic reaction, E_{A} is the anode potential, and E_{A}^{o′} is the standard potential at the interface at neutral pH. In the equation, the term (E_{A}−E_{A}^{o′}) defines the activation overpotential when voltage is applied, and j_{oA} defines the effectiveness of catalyst for sulfide/sulfur oxidation.
The overall rate of sulfide oxidation also depends on medium conductivity:

$$j = \frac{{V}_{app} σ}{d} , \qquad Eq . ( 11 )$$

where Vₐₚₚ is the applied voltage, d is the distance between two electrodes 18 and 29, and σ is the conductivity of the medium located between the electrodes 18 and 20.

Finally, the overall current will also rely on the electrode surface area A:

l=jA Eq. (12).

From the electrochemical point of view, the above equations show that the sulfide removal efficiency will depend on the applied voltage, the effectiveness of catalyst for sulfide oxidation, medium conductivity, and electrode surface area.
The changes of pH induced by the electrochemical reactions, in the bulk of the working fluid 13, at the anode 18, or at the cathode 20, can expedite the formation of corresponding crystals containing alkaline earth metal ions of calcium and magnesium.

| | Ksp at 25° C. |
|---|---|
| Formula | (mol/L)\hat{ }n |
| Ca3(PO4)2 | −28.92 |
| Ca4H(PO4)3:3H2O | −47.08 |
| CaHPO4:2H2O | −18.995 |
| Ca5OH(PO4)3 | −58.33 |
| MgHPO4:3H2O | −18.175 |
| Fe3(PO4)2:8H2O | −36 |
| FePO4:2H2O | −26.4 |
| FePO4 | −25.8 |
| Fe3(PO4)2 | −36 |
| CaHPO4 | −19.275 |
| CaHPO4:2H2O | −18.995 |
| Mg3(PO4)2 | −23.28 |
| NH4MgPO4:6H2O | −13.17 |

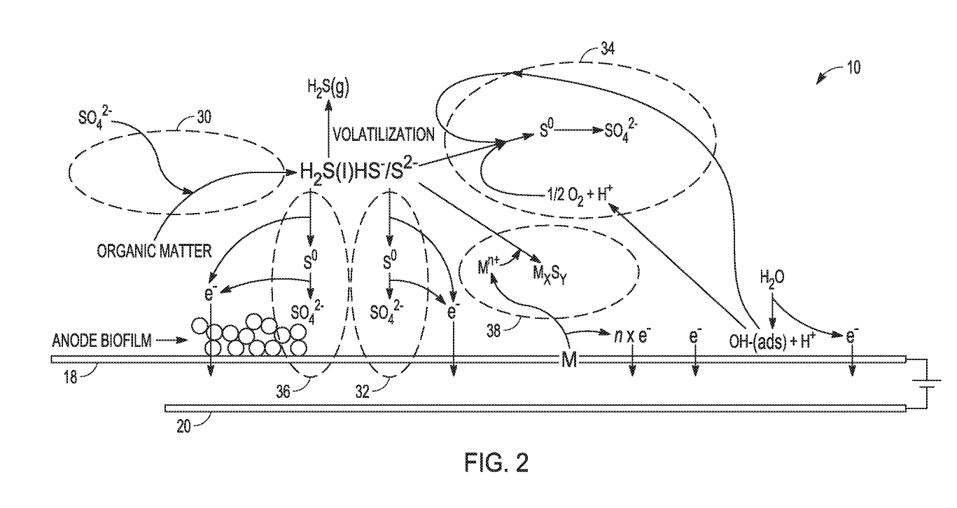

It is further proffered by the inventors that sulfide removal can be the product of several concurrent reactions that can function alone or together. These possible mechanisms are shown in FIG. 2. In an example, a first pathway 30 involves the inhibition of sulfate production. The present inventors believe that inhibition of sulfate production helps to mitigate the formation of sulfide in the working fluid 13, and the inhibition can occur when non-active electrode materials (e.g., SnO₂ or PbO₂ coated on Ti, and boron-doped diamond) are included in system 10. These non-active electrode materials have a wide window for the formation of hydroxide radicals (OH.) before anode potential reaches the point of water oxidation. In another example, sulfate production is inhibited by inhibiting anaerobic microorganisms by creating a micro-aeration condition as the applied voltage overcomes water electrolysis potential, or when a sacrificing anode releases toxic metal cations, such as cupric cations (Cu²⁺).

In an example, a second pathway 32 comprises abiotic direct oxidation of sulfide. In an example, abiotic direct oxidation occurs at the first anode 18A and the second cathode 20B. In some examples, abiotic direct oxidation of sulfide generates polysulfide and elemental sulfur.

In an example, a third pathway 34 includes mediated oxidation. In an example, in pathway 34 anodically generated oxygen gas and free radicals act as oxidants that can react with sulfide. In an example, the reaction between an oxidant and sulfide generates one or more of polysulfide, elemental sulfur, and various sulfur oxyanions. The process of the pathway 34 can be abiotic, e.g., via sulfide auto-oxidation, or biotic, e.g., mediated by sulfide oxidation microorganisms and sulfur oxidation microorganisms.

In an example, a fourth pathway 36 comprises biotic direct oxidation. In an example, in pathway 36 electron transfer between sulfide and an anode 18 is mediated by a microbial biofilm, such as a microbial biofilm as described above. In an example, sulfide is directly oxidized on the microbial biofilm.

In an example, a fifth pathway 38 comprises metal binding, which can lead to precipitation of a metal sulfide. In an example of pathway 38, an anode, such as the first anode 18A, is at least partially a sacrificing metal anode that releases one or more metal ions. In an example, the one or more released metal ions can react with one or more sulfide species to form a metal sulfide that is more readily separated from the working fluid. In an example, the one or more released metal ions can react with the one or more sulfide species to form a metal sulfide that is insoluble or substantially insoluble in the working fluid 13. In this manner, the metal ions can serve as sulfide scavengers that, in some examples, form various types of amorphous or crystalline metal sulfides with low solubility product constants. For example, if the sacrificing metal anode includes iron, the system 10 can produce iron sulfide compounds, such as mackinawite (Fe₍₁₊ₓ₎S), pyrrhotite (Fe₍₁₋ₓ₎S), pyrite (FeS₂), or if the sacrificing metal anode includes copper, the system 10 can produce copper sulfide compounds, such as chalcocite (Cu₂S) and covellite (CuS). Removal of the metal sulfides can result in lower levels of dissolved sulfide species and facilitates easy removal of the solid species. In a similar fashion, the released metal anions precipitate phosphate to contribute to the phosphate removal process.

System 10 can result in a substantial amount of the one or more phosphorus species being removed from the working fluid. For example, about 70 wt % to about 99 wt %, or about 90 wt % to about 99 wt %, for example, at least about 71 wt %, 72, 73, 74, 75, 76, 77, 78, 79, 80, 81, 82, 83, 84, 85, 86, 87, 88, 89, 90, 91, 92, 93, 94, 95, 96, 97, or 98 wt % of the one or more phosphorous species can be removed from the working fluid after the voltage is applied. Similarly, system 10 can result in a substantial amount of the one or more sulfide species being removed from the working fluid. For example, about 70 wt % to about 99 wt %, or about 90 wt % to about 99 wt %, or less than about, equal to about, or greater than about 71 wt %, 72, 73, 74, 75, 76, 77, 78, 79, 80, 81, 82, 83, 84, 85, 86, 87, 88, 89, 90, 91, 92, 93, 94, 95, 96, 97, or 98 wt % of the one or more sulfide species is removed from the working fluid after the voltage is applied.

### EXAMPLES

Various embodiments of the present invention can be better understood by reference to the following Examples which are offered by way of illustration. The present invention is not limited to the Examples given herein.

### Example 1: Removal of Sulfides From Synthetic Media

### Chemicals and Working Fluid

Sodium sulfide solution was prepared from sodium sulfide nonahydrate (Na₂S.9H₂O) solids of ACS reagent grade (Sigma-Aldrich, St. Louis, Mo.), and buffered at pH 7.0 by 100 mM phosphate buffer solution (PBS).

### Electrode Materials and Preparation

Electrodes materials used were plain carbon cloth (Fuel Cell Earth LLC, Stoneham, Mass.) and stainless steel meshes (AISI 304, 316 and 430) with a wire diameter of 0.8 mm (mesh #4, McMaster-Carr, Elmhurst, Ill.). Carbon cloth electrodes were 4.5 cm in length and 1.0 cm in width, and the effective surface area was 4.0×1.0=4 cm². Stainless steel mesh electrodes were 4.5 cm in length and 0.7 cm in width with a surface area was 2.8 cm². Electrodes were glued to titanium wire of 30 gauge (0.255-mm in diameter. Esslinger & Co., Saint Paul. Minn.) via conductive silver epoxy (Fisher Scientific. Pittsburgh, Pa.).

### Reactor Set-up and Operation

Serum bottles of 160 mL with a working volume of 100 mL, capped with viton stops and sealed with an aluminum cap, were used as reactor vessels. Titanium wire penetrated the viton stops for electrode insertion and the penetrated sites were sealed with marine glue. Three electrode configurations inside the reactors were studied, including immersed (whole pieces of electrodes immersed in media), half-immersed (half piece of electrode immersed in media), and suspended (electrodes suspended in headspace without contact with liquid). Voltage was applied by connecting the wire to power supplies at the pre-determined voltage levels of 1 V, 2 V, 3 V, or control without voltage. Serum bottles were controlled at two temperature levels of 25° C. and 35° C. in water baths.

For electrochemically assisted reactors, electrodes were inserted to serum bottles in a similar fashion as described herein. Reactors were incubated at either 25° C. or at 35° C. in a temperature controlled incubator with daily manure mixing. Electrical current was measured with a multi-meter at 8 h intervals in the first 24 h. The produced biogas volumes were measured on the designated sampling dates by water displacement of hydrochloric acid solution of pH 2 in a calibrated glass cylinder manometer. Experimental duration was 7 days for continuous mode of voltage application, and 35 days for intermittent voltage application.

### Gas Composition Analysis

Biogas composition of methane, carbon dioxide, oxygen gas, hydrogen gas, and nitrogen gas was analyzed using a gas chromatograph (CP-4900 Micro-GC, Varian Inc., Palo Alto, Calif.) equipped with two columns of molecular sieve 5A and Porapak Q. Helium gas was used as the carrier gas. The temperatures for the sampling line, the injector, and columns were set at 50, 110, and 80° C., respectively. Gas components were determined by a thermal conductivity detector (TCD) equipped to the micro-GC. Volumetric levels of hydrogen sulfide in biogas were determined using RAE Systems hydrogen sulfide tubes of varying ranges based on the real concentration. Dilution of biogas with air was necessary in some samples because of the high level of hydrogen sulfide.

### Liquid Analysis

Liquid samples were collected from serum bottles after well mixing. Each digestate sample of 10 mL was centrifuged at 3000×G for 15 min before the supernatant was used for sulfate, reactive phosphorus and iron analysis by colorimetric methods using commercial testing kits (TNTplus™, Hach Company, Loveland, Colo.) with a UV-Vis spectrophotometer (Hach DR 5000) following the protocol for each assay. Before sulfate analysis, high purity chitosan powder of 0.3 g was added to samples to flocculate remaining solids for lower turbidity. Sulfide concentration was determined by ion-selective glass electrode (Cole Parmer, Chicago, Ill.) according to Standard Methods for the Examination of Water and Wastewater.

### Electrochemical Characterization

Cyclic voltammetric measurements were carried out using a Reference 600 potentiostat (Gamry Instruments, Warminster, Pa.) in a three electrode configuration, consisting of a platinum wire counter electrode and Ag/AgCl (3 M NaCl) reference electrode (+0.207 V versus a standard hydrogen electrode. SHE). The projected surface area of working electrodes subjected to test was 2.32 cm². Tested electrode materials included carbon cloth, stainless steel AISI 304, 316, and 430. Before a test, stainless steels were polished for its surface with sandpaper of 400 grit (22 μm) silicon carbide. The media for the test was 100 mM phosphate buffer solution (pH=7.2; oxygen gas stripped) with sodium sulfide concentration of 0 and 5 mM, respectively. The scanning rate was between 10 mV/s to 2000 mV/s but only the results of 50 mV/s scan were given.

Electrochemical impedance spectroscopy (EIS) test was performed in liquid dairy manure using Reference 600 potentiostat to quantify the resistance of the whole electrolytic cells. The test was done in two-electrode configuration, with anode as the working electrode and cathode as the reference and counter electrodes. The frequency for EIS analysis ranged from 1 MHz to 1 Hz at 20 points/decade. The AC amplitude was 1 mV.

### Removal of H₂S in Synthetic Media

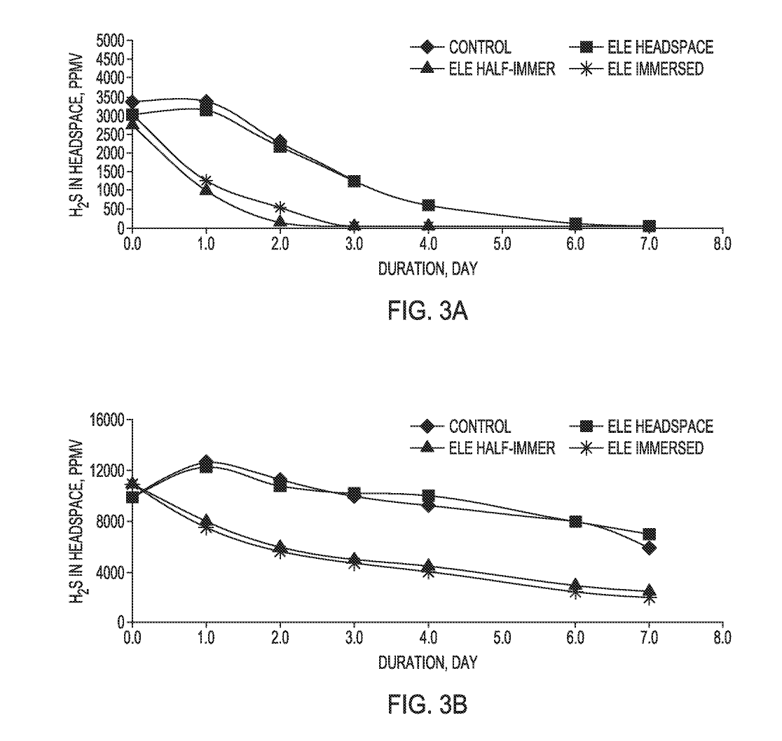

FIGS. 3A and 3B show time profiles of the H₂S level in the synthetic media (in ppmw) during electrochemical oxidation at different positions within the serum bottles. For both FIG. 3A and FIG. 3B, carbon cloth electrodes were used, the applied voltage was 1 V, and the electrochemical oxidation process was maintained and at room temperature (25±2° C.). FIG. 3A show the H₂S level for electrochemical oxidation carried out with the electrodes in 2 mM Na₂S media (64 mg-S²⁻/L), while FIG. 3B shows the H₂S level for electrochemical oxidation with the electrodes in 10 mM Na₂S media (320 mg-S²⁻/L). As can be seen in FIGS. 3A and 3B, at an applied voltage of 1 V with the carbon cloth electrodes, the headspace hydrogen sulfide level continuously dropped in both 2 mM and 10 mM sulfide solutions. FIGS. 3A and 3B also show that the headspace sulfide level was found to slightly increase in the first 24 h in the control groups, suggesting the equilibrating process of hydrogen sulfide from the dissolved phase in water to the volatilized phase in headspace. When electrodes were placed in headspace without contact with liquid medium, the removal was not distinguishable from the control, in which condition the sulfide oxidation was probably initiated by the remaining oxygen in either water or headspace to polysulfide. Autoxidation of aqueous sulfide was observed to be catalyzed by the intermediate of disulfide followed by chain growth to form polysulfide and then to polythiosulfite and gradually to thiosulfate and sulfite/sulfate. The similar trends of sulfide removal between the configuration with electrodes in headspace and the control indicated that the adsorption of hydrogen sulfide to carbon cloth did not cause an observable change of concentration, which distinguished the sorption property of the graphitic carbon fiber used here from that of the activated carbon and its fiber. Hydrogen sulfide was depleted by half-immersed and immersed electrodes after 3 or 4 days when the initial Na₂S concentration was 2 mM. When the initial Na₂S concentration increased to 10 mM, H₂S was not depleted in 7 days but suppressed to between 2000 and 2500 ppm, which was substantially lower than that of the control (7000 ppm).

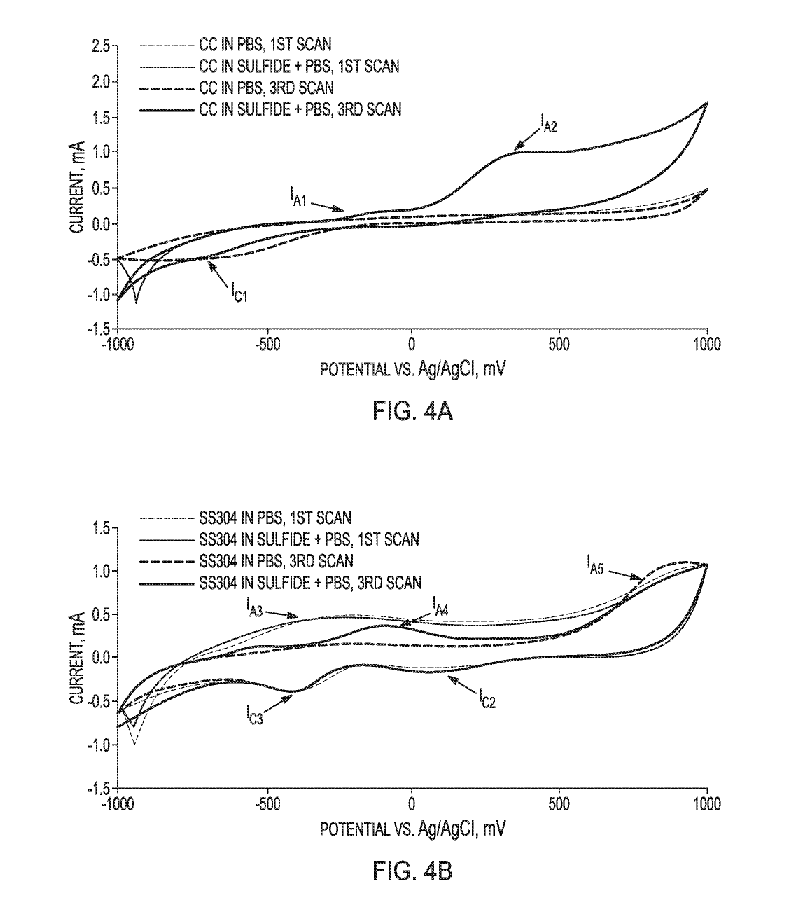

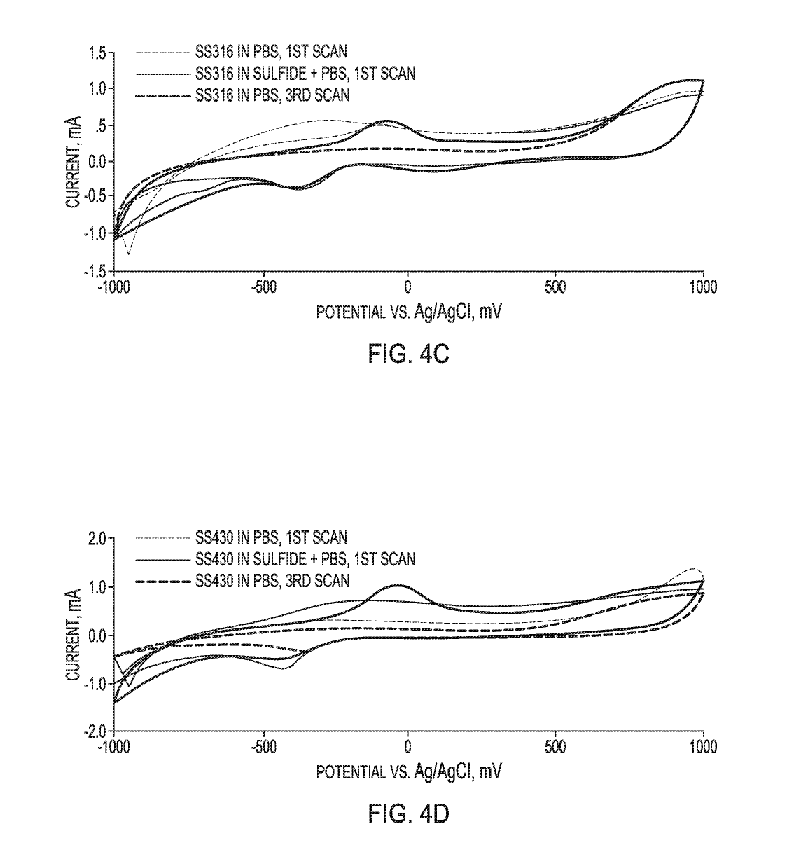

The above results show that the anode oxidation of sulfide (or hydrogen sulfide electrolysis) on carbon cloth electrode at a voltage smaller than that of water electrolysis (1.23 V) was feasible. This oxidation was theoretically predicted feasible by the potential differences between redox couples of either the half reaction of sulfide/bisulfide oxidation to elemental sulfur (−271 mV vs. Standard Hydrogen Electrode (SHE), at pH=7 and 1 M) or even to sulfate (−213 mV; but not like to occur due to kinetics limitation), and the other half reaction of water reduction to hydrogen gas (−414 mV vs. SHE at pH=7), which have relatively small potential differences of 0.143 V and 0.201 V, respectively. The cyclic voltammetry results showed the distinct voltammograms of carbon cloth electrode in PBS media with and without sulfide presence (shown in FIGS. 4A-4D), demonstrating the extra oxidation peaks associated with sulfide oxidation at around −60 mV vs. Ag/AgCl (Iₐ₁, or +147 mV vs. SHE; absent in the first scan of sulfide solution) and at around +400 mV (Iₐ₂, or +607 mV vs. SHE). Since the peak Iₐ₁ only started to appear after the first scan, it suggested to be a result of polysulfide oxidation. The peak Iₐ₂ was more likely a result of combined sulfide and polysulfide oxidation to elemental sulfur. The current decrease from the first to the third scan tended more to be a result of sulfide concentration decrease at boundary rather than being deactivated by sulfur deposition, because the replenishment of sulfide solution completely recovered the current at the consequent scan. The further current increase from anodic sweep after Iₐ₂ suggested the oxygen chemisorption and evolution reactions. The cathodic scan, both with and without sulfide presence, showed a reduction peak of I_{c1} at −650 mV, and therefore, indicated the hydrogen adsorption followed by hydrogen evolution reaction. The lack of additional reduction peak indicated the irreversibility of sulfide oxidation at the tested potential range when carbon cloth was used as electrode. In fact, sulfide oxidation on graphite disk electrode was observed in an earlier study, and later this phenomenon was used to mitigate sulfide pollution in brine by using carbon felt with further kinetics elucidation for graphite rod. Catalysis to sulfide oxidation by carbon materials can be irreversible as reported in glassy carbon (or vitreous carbon) electrode. Therefore, as reported in our results, it was feasible to effectively oxidize sulfide using graphitic carbon cloth in single chamber configuration without using platinum counter electrode or selective ion exchange membrane between electrodes. The use of the less expensive material of carbon cloth at low voltage application may be promising because it may potentially increase coulombic efficiency and minimize intermediates generation (e.g., oxygen gas generation in mixed metal oxides electrodes) during sulfide removal.

Voltammograms of the three types of stainless steel (AISI 304, 316, and 430) displayed common anodic and cathodic peaks (FIGS. 4A-4D are cyclic voltammograms of electrode materials in 100 mM phosphate buffer solution with and without 5 mM sodium sulfide. A, carbon cloth; B, stainless steel 304; C, stainless steel 316; and D, stainless steel 430. The scan rate was 50 mV/s.). The presence of sulfide did not insert any additional peak in the first scan compared to the voltammograms in PBS solution, but showed the same broad anodic peaks of Iₐ₃ (between −230 and −210 mV) and Iₐ₅ (>+500 mV), and cathodic peaks I_{c2} of (+100 mV) and I_{c3} (−380 mV). The broad anodic peak of Iₐ₃ suggested the oxidation of iron to form passive film, and Iₐ₅ indicated the oxidation of metal oxide to higher oxidation valence states, followed by oxygen evolution reaction thereafter. The reduction peak of I_{c3} was suggested to relate to the reductive dissolution of hydrated ferric oxide to ferrous, and the peak I_{c2} was attributed to the reduction of chromium oxide from six to three valence state based on a test for AISI 316. In the following scan on stainless steel represented by the third scan, all showed an additional peak of Iₐ₄ at −60 mV. After the first anodic scan, stainless steel surface was passivated with metal oxide which may display catalytic effect for sulfide oxidation to elemental sulfur, although the effect may be smaller than that of carbon cloth shown in the test. These results suggested that the direct anodic sulfide oxidation will be likely to occur for the three types of the tested stainless steel materials, and the indirect oxidation by reactive oxygen species and oxygen gas, and chemical binding to dissolved metal ions can assist in scavenging sulfide from media.

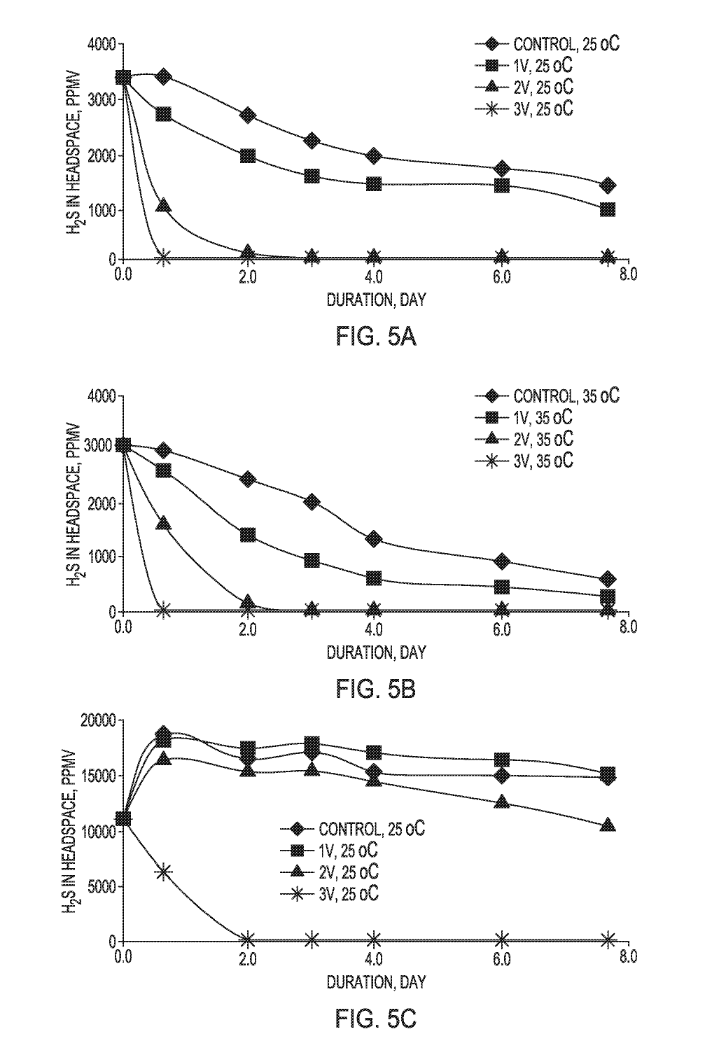

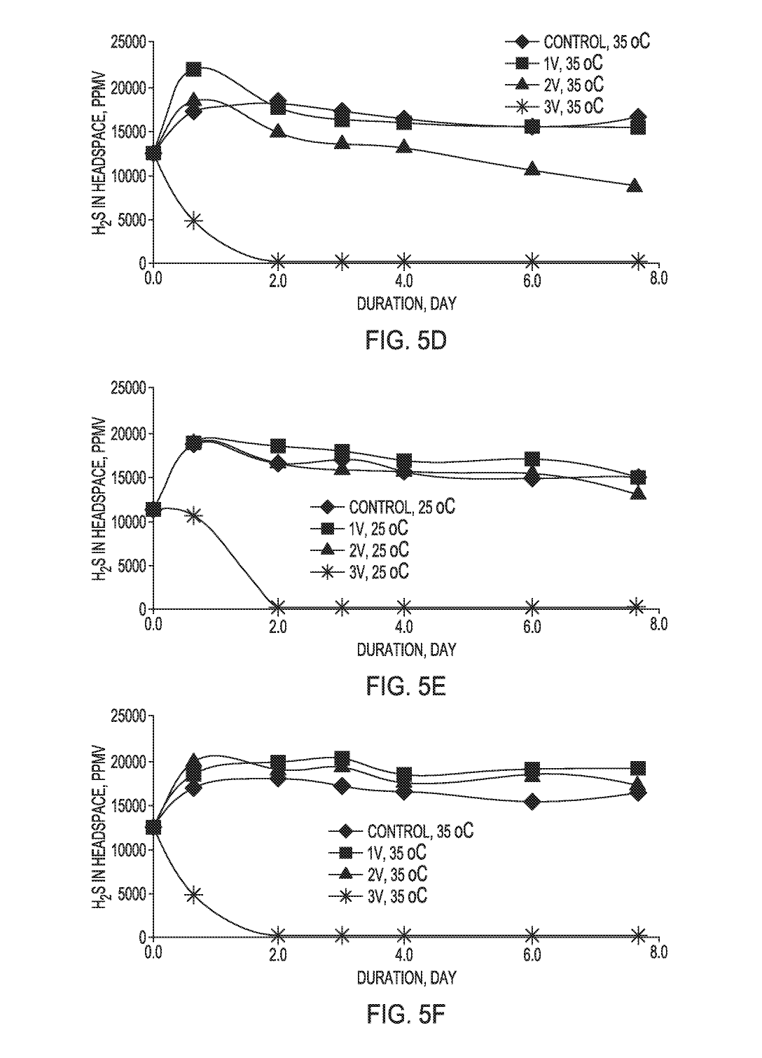

FIGS. 5A-SF show time profile graphs of headspace H₂S levels generated with synthetic media during electrochemical oxidation at 1, 2 and 3 V, with each graph representing the data for a different combination of temperature, electrode material, and media concentration. FIG. 5A shows the levels resulting for carbon cloth electrodes in a 2 mM Na₂S media solution at a temperature of 25° C. when applying 1 V, 2 V, and 3 V. FIG. 5A also includes a control data series (e.g., no voltage applied) 506 showing the headspace H₂S level when the same carbon cloth electrodes are placed in the same 2 mM Na₂S media at 25° C. but with no voltage applied to the electrodes. FIG. 5B also shows the H₂S resulting from carbon cloth electrodes in a 2 mM Na₂S media at 1 V, 2 V, 3 V, and control conditions, but at 35° C. FIGS. 5C and 5D also show data for carbon cloth electrodes, but in a 10 mM Na₂S media solution rather than a 2 mM solution. FIG. 5C shows the results for 25° C. at applied voltages of 1 V, 2 V, 3 V, and control conditions, while FIG. 5D shows the results for 35° C. at voltages of 1 V, 2 V, 3 V, and control conditions. FIGS. 5E and 5F show data for stainless steel electrodes in 10 mM Na₂S media. FIG. 5E shows the results for 25° C. at applied voltages of 1 V, 2 V, 3 V, and control conditions. As can be seen in FIGS. 5A-SF, when applied voltage on carbon cloth was increased to 2 and 3 V, the headspace hydrogen sulfide expectedly decreased at a higher rate, partially because of sulfide being reacted at a faster rate caused by the increased driving force (overpotential) for oxidation which was indicated by higher anode potentials (TABLE 1), and partially because of intermediates of oxygen gas generation which assisted in sulfide oxidation. Since the tested pH value of the media was relatively stable during the operation in 0.1 M PBS buffer, the decrease of hydrogen sulfide in headspace indicated the removal of sulfide species in media rather than the redistribution (dissociation/association) between different sulfide species. When the voltage increased from 1 V to 2 V and 3 V at 25° C., the calculated sulfide removal rate by carbon cloth was boosted from 53 g-S/d/m²-anode to 127 and >203 g-S/d/m²-anode in 2 mM Na₂S, and from 177 g-S/d/m²-anode to 203 and 719 g-S/d/m²-anode in 10 mM Na₂S (TABLE 2). For 3 V voltage application, hydrogen sulfide was not detectable after 0.65 day or 2 day depending on the initial concentration of sodium sulfide solution. Starting at 2 V, carbon cloth anode became dimensionally instable in sulfide solution and part of the graphite fiber consisting the carbon cloth disintegrated into the solution. This phenomenon would substantially affect the service life of the anode material and required the anode replacement over time. Meanwhile, water electrolysis produced appreciable amounts of oxygen and hydrogen gas when voltage was 2 V. and a substantial amount of gases when voltage was 3 V. Cyclic voltammetry results also suggested the occurrence of oxygen evolution reaction and the production of oxygen at the higher voltage may enhance the autoxidation of aqueous sulfide, which is a phenomenon of sulfide oxidation catalyzed by the intermediate of disulfide followed by chain growth to form polysulfide and then to polythiosulfite and gradually to thiosulfate and sulfite/sulfate.

TABLE 1
Measured electrode potentials for three applied voltages at 25° C.)

| | Electrical potential, φ | | | | |
|---|---|---|---|---|---|
| | | | Water | | Water |
| | | Anode | oxidation | Cathode | reduction |
| Anode-Cathode | Voltage | V vs. | V vs. | V vs. | V vs. |
| Combination | V | SHE | SHE | SHE | SHE |

In 0.1M phosphate buffer solution (pH ~7.0)

| | | | | | |
|---|---|---|---|---|---|
| CC-CC* | 1 | +0.89 | +0.814 | −0.11 | −0.415 |
| SS-CC | 1 | +0.95 | | −0.05 | |
| SS-SS | 1 | +1.23 | | 0.23 | |
| CC-CC | 2 | +1.43 | | −0.57 | |
| SS-CC | 2 | +1.49 | | −0.51 | |
| SS-SS | 2 | +1.42 | | −0.58 | |
| CC-CC | 3 | +1.79 | | −1.21 | |
| SS-CC | 3 | +1.77 | | −1.23 | |
| SS-SS | 3 | +1.71 | | −1.29 | |

*Through the application, the following abbreviations were used: CC, carbon cloth; SS, stainless steel; CC/CC, carbon cloth anode and cathode; SS/CC, stainless steel anode and carbon cloth cathode; and SS/SS, stainless steel anode and cathode.

TABLE 2
Sulfide removal rate calculated from the results of within two days'
operation at different applied voltages with carbon cloth electrodes

| Initial Na₂S | Voltage | Sulfide removal rate | | |
|---|---|---|---|---|
| concentration | V | 25° C. | 35° C. | Unit |
| 2 mM | 1.0 | 53 (±1) | 44* | g-S/d/m² |
| | 2.0 | 127 (±17) | 128 (±12) | |
| | 3.0 | >203 (±61)** | >203 (±61)** | |
| 10 mM | 1.0 | 177 (±203) | 121* | |
| | 2.0 | 203 (±98) | 235 (±173) | |
| | 3.0 | 719 (±112) | 816 (±117) | |

*These two conditions were conducted without replicates.
**All sulfide was removed in two days in these two conditions, therefore resulting in a lower calculated (apparent) removal rate than the capability of the removal rate.

With carbon cloth electrodes treatment in 10 mM sulfide solution, the hydrogen sulfide level was observed to be much lower when temperature elevated from 25 to 35° C. at 2 and 3 V (FIGS. 5C and 5D) and the calculated removal rate was larger at the higher temperature which, possibly resulted from an increased oxidation rate of sulfide. To the contrary, at 1 V, higher temperature condition (35° C.) yielded a final headspace hydrogen sulfide level comparable to that of the lower temperature (25° C.). The reason may be that despite a higher reaction rate at higher temperature, a higher temperature also gave rise to the Henry's law constant of hydrogen sulfide thereafter its concentration in headspace as well. Stainless steel electrode behaved similar to carbon cloth in headspace hydrogen sulfide removal at 3 V, but was less effective than carbon cloth at 2 V or lower (FIGS. 5E and 5F). However, due to the small solubility product constants of iron phosphates (e.g., vivianite, Ksp=10⁻³⁶, and strengite, Ksp=10^{-26.4}, retrieved from Mineql+thermodynamic database), the competition for iron ions between sulfide and phosphate in 0.1 M PBS solution must occur and therefore reduce the sulfide removal efficiency. Meanwhile, temperature seemed to have played a less important role in the electrochemical oxidation rate of sulfide by stainless steel electrodes, and therefore headspace hydrogen sulfide was dominated by higher volatilization at higher temperature at lower oxidation rate at 1 and 2 V in FIGS. 5E and 5F).

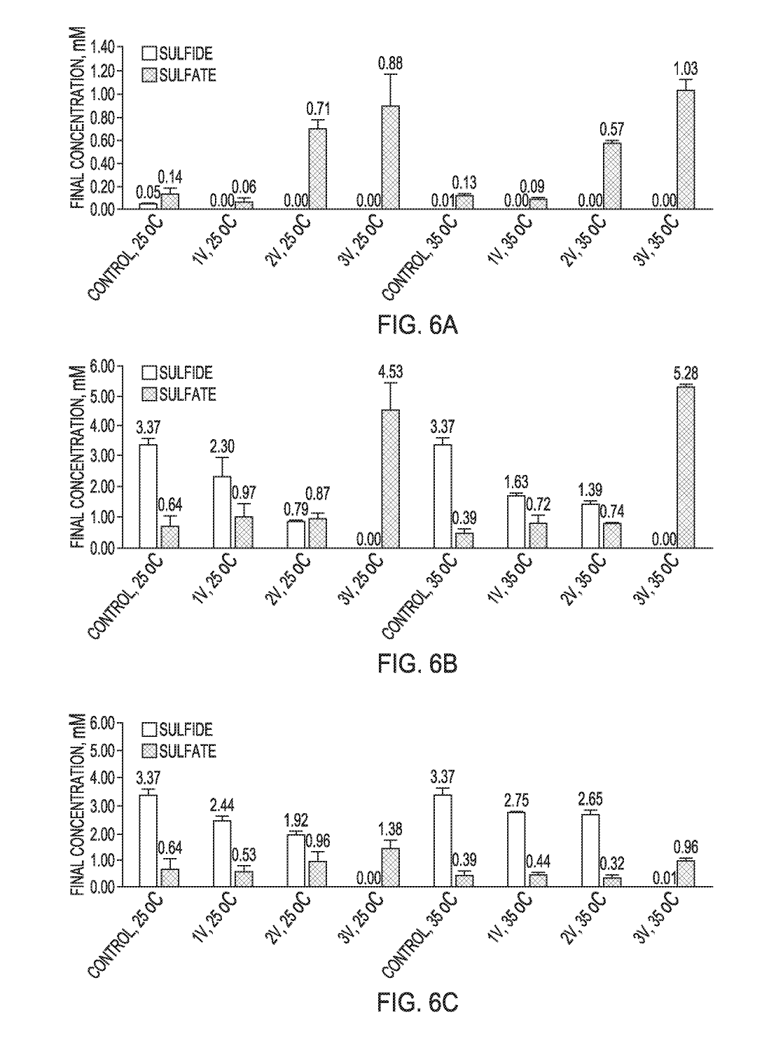

FIGS. 6A-6C show sulfide and sulfate concentrations in the final synthetic media after electrochemical oxidation. FIG. 6A shows the concentrations in 2 mM Na₂S media after electrochemical oxidation with carbon cloth electrodes. FIG. 6B shows the concentrations in 10 mM Na₂S media after electrochemical oxidation with carbon cloth electrodes. FIG. 6C shows the concentrations in 10 mM Na₂S media after electrochemical oxidation with stainless steel electrodes. A listing of 0.00 for the sulfide means that the sulfide concentration was less than the detection limit of 0.5 μM (about 0.016 mg/L)). The liquid analysis of FIGS. 6A-6C showed that after electrochemical oxidation, the sulfide concentration decreased and the sulfate concentration generally increased. In the media with the original 2 mM Na₂S solution, 2 V voltage treatment increased the sulfate concentration from 0 to 0.71 and 0.57 mM, and 3 V treatment increased the concentration to 0.88 and 1.03 mM, at 25° C., and 35° C. respectively. The sulfide level in the media decreased to a level less than the detection limit of the method (0.5 μM or 16 μg/L) except in the control reactors without voltage application. For the 10 mM sulfide media, the remaining sulfide level after about 8-day treatment was again substantially lower than that of the control reactors, and 3 V voltage completely removed sulfide at both electrode materials and temperatures. However, the sum of sulfide and sulfate in all reactors were not balanced with the original sulfide concentration, indicating the accumulation of a wide spectrum of sulfur intermediates and products during sulfide oxidation, including disulfide, polysulfide, and elemental sulfur at lower anode potential and further to polythiosulfite, sulfite, and thiosulfate, and the remaining portion of hydrogen sulfide volatilized to headspace or removed by sampling for analysis. Accumulation of these intermediates and products were also widely reported in natural and artificial water samples. Nevertheless the complexity in oxidation products, conversion of sulfide to all of the other sulfur species is helpful in reducing hydrogen sulfide concentration in gas layer. Stainless steel electrode behaved similar to carbon cloth in sulfide removal when applied voltage was 3 V, but was less effective than carbon cloth at 1 or 2 V (FIG. 6C). The sulfate concentrations with stainless steel treatments were correspondingly smaller than that with carbon cloth treatments of the same voltage level. Since iron dissolution from anode was expected to occur, binding of ferrous with sulfide made up another important sulfide sink; however, the quantitative results were not obtained in this study.

Previous studies on hydrogen sulfide concentration in swine or dairy manure in anaerobic digestion usually observe peak hydrogen sulfide content in biogas/headspace gas within 5000 ppm (or 0.5% of gas volume) at the first few days of digestion which corresponds to a total sulfide content in digestate up to 185 mg-S/L (or 5.78 mM of sulfide) assuming pH=8 and temperature of 35° C., and dimensionless Henry's law constant of 0.4143. Based on the observed results of sulfide removal rate in our study, it is possible to completely remove this sulfide level in one day by using between 2.3 cm² and 42 cm² of carbon cloth electrode per liter digestate, depending on the levels of applied voltage.

### Example 2: H₂S Removal with Biogas Production from Dairy Manure

### Substrate and Inoculum Preparation

Manure samples as an anaerobic digestion (AD) working fluid were collected from the dairy barn in the Dairy Cattle Teaching & Research Facility at University of Minnesota, St Paul. Minn. The manure sample was mixed with tap water at a manure/water ratio of 1:2, followed by 5 min. manual homogenization. It was sequentially filtered through meshes with open-pore sizes of 2 mm and 0.295 mm. Initial inoculum of anaerobic sludge was collected from Blue Lake Municipal Wastewater Treatment Plant located in Shakopee, Minn., and was used to inoculate a dairy manure fed continuously maintained digester in lab. The inoculum used in this experiment was then collected from the digester.

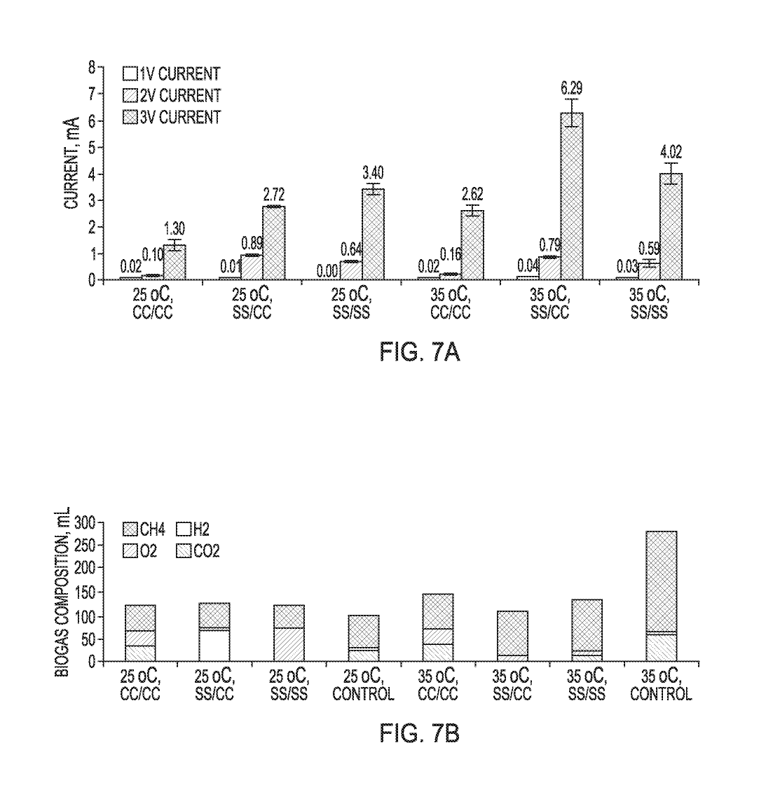

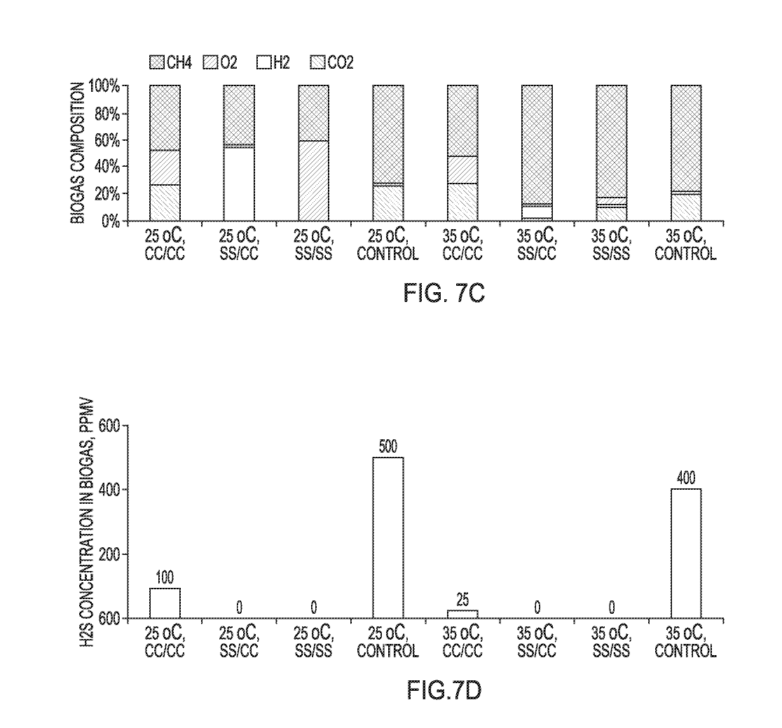

FIG. 7A shows the current in the electrolytic cells at 3 levels of voltage applications (1, 2, and 3 V), with different combinations of electrodes (carbon cloth and carbon cloth (CC/CC), stainless steel and carbon cloth (SS/CC), and stainless steel and stainless steel (SS/SS)), and at two temperature (25 and 35° C.). The resulting biogas composition after electrochemical oxidation at 3V with the same electrode combinations and temperatures are shown in FIG. 7B (in mL of each component) and FIG. 7C (in percentage of the total biogas). FIG. 7D shows the sulfide concentration in the biogas after electrochemical oxidation with the same electrode combinations and temperatures. A concentration of 0 ppmv indicates that there was less H₂S than the detection limit of the analysis method.

### Continuous Voltage Application

The results demonstrated the rapid increase in current when voltage increased from 1 V to 2 and 3 V. The drastic current increase when voltage increased from 1 V to 2 V and further to 3 V was because of the overcome of overpotentials for both anode and cathode reactions for water electrolysis and anode corrosion, according to Butler-Volmer equation or Tafel equation which approximately predict exponential increases of current (density). The increase of the absolute values of overpotentials at both electrodes in dairy manure was confirmed by the measured electrode potentials at the three levels of voltage, following the same pattern as in synthetic media shown in TABLE 1.

The current increase also accompanied with the decrease of overall resistance (both ohmic and polarization resistances of the whole system; polarization resistance included the charge transfer and diffusion resistances, because of the occurrence of anode and cathode reactions (FIG. 7). Visual inspection on the resistance information from EIS test also indicated that at 1 V, CC/CC had a lower resistance than SS/CC, while at 2 V and above, CC/CC had a higher resistance, suggesting a higher catalytic effect of CC on anode reactions at 1 V than that of SS. The largest current of 6.29 mA occurred at the SS/CC (stainless steel anode and carbon cloth cathode) combination at 3 V at 35° C. As a comparison, the addition of oxygen gas as an electrochemical intermediate at the level of 29, 57, and 114 mg/L/d corresponded to a continuous current level of 0.20, 0.40, and 0.80 mA calculated from Faraday's law when assuming a 100% Coulombic efficiency. At 1 V voltage the water electrolysis hardly occurred, because either anode or cathode potential, or both electrode potentials, were not high enough to overcome overpotentials. As a result, the biogas tested after 7 days' digestion was consisted of methane and carbon dioxide as that of the control reactor.

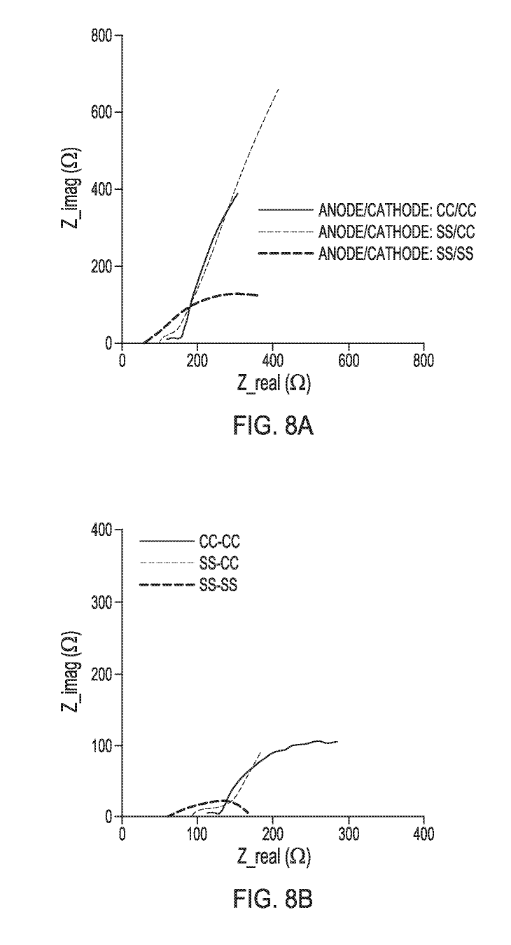

FIGS. 8A and 8B show complex plane (Nyquist) plots of electrochemical impedance spectroscopy (“EIS”) of different electrode combinations in dairy manure. FIG. 8A shows the EIS scanned at 1 V, and FIG. 8B shows the EIS scanned at 2 V.

The biogas production and composition with the treatments at 3 V are shown in FIGS. 7B, 7C, and 7D. Because of the high current levels (between 1.3 mA and 6.29 mA depending on reaction conditions) at 3 V voltage which continuously generated oxygen gas, total methane generation was negatively affected at both temperatures. The reason for the decrease in methane generation was the aerobic respiration with organic working fluid consumption and the inhibition to methanogens when oxygen was introduced. The impact on methane generation was especially pronounced at 35° C. (FIG. 7B) as a result of higher current and therefore oxygen generation rates. The biogas composition was consequently altered as well, although the amount of oxygen gas was small among all treatments, i.e., 4.9% for SS/SS at 35° C., while in other treatments oxygen was less than 1.5%. At 25° C., all electrochemical treatments resulted in a significant portion of hydrogen gas (26% and 59% of total biogas volume), and the methane content (40% to 47%) was much less than the control reactor (73%). The sum of methane and hydrogen gas accounted for 97.1% and 99.7% for the SS/CC and SS/SS treatments. This gas mixture may be used in combustion engine as hythane, which may enhance combustion rate, extend the lean limit of combustion of biogas, and improve brake thermal efficiency and brake power, as compared to methane alone. At 35° C., methane content of reactors with stainless steel anode was comparable to the control while carbon dioxide content (2.9% and 10%) was much smaller than the control (21%). However, all 19 extracellular enzymes (phosphatases, esterases, lipases, proteinases, glucosidases, etc.) concentrations in digestate with SS anode at 3 V treatment, tested via API® Zyme strip, were found much lower than those of the control reactors, and CC anode resulted in enzyme concentrations in between. These results showed a possibility of producing clean biogas ready for use in combustion engines without upgrading, by applying electrochemical systems in AD reactors, but some technical issues will have to be solved for long-term operation of a reactor, e.g., how to maintain high methane yields and prevent the loss of microbial and exoenzyme activities.

At a 1 V voltage, hydrogen sulfide was removed with stainless steel anode, by 43% and 14% at 25° C., and by 34% and 6% at 35° C., for SS/CC and SS/SS combinations, respectively. Contrary to the result in synthetic media test, the sulfide removal effect of carbon cloth was not observed in this test, which can be a result of the small surface area of electrode and interferences caused by background chemical matrices which may compete with sulfide oxidation or shift the selection toward other electroactive species. In the future, experiment with larger carbon cloth electrode surface area will be conducted to signify the effect on sulfide removal. At 2 V and 3 V voltage treatments, hydrogen sulfide was completely removed when stainless steel was used as anode. Carbon cloth anode removed 55% of hydrogen sulfide at 25° C. and 44% at 35° C. at 2 V, and removed 80% at 25° C., and 94% at 35° C. at 3 V. The liquid analysis showed that under 1 V voltage, sulfate level in all reactors was similar. But at 3 V voltage, the sulfate level was significantly reduced in the electrode combination of SS/CC and SS/SS while the CC/CC had no substantial effect on sulfate level compared to the sulfate level of the control. With the release of ferrous ion from anode, precipitates of ferrous sulfide may also be present but this composition was not analyzed in this current study. Therefore, when SS anode was utilized, intermediate oxidation products of sulfide, or sulfide minerals sinks, together with a small portion of sulfate sink, took most part of sulfide from the digestate. Meanwhile, reactive phosphate level in digestate was completely removed by SS/CC and SS/SS combination under 3 V, with simultaneous increase in reactive iron concentration. Similar co-removal of sulfide and phosphate was observed in sewers originally aiming for sulfide removal with iron dosage.

### Intermittent Voltage Application

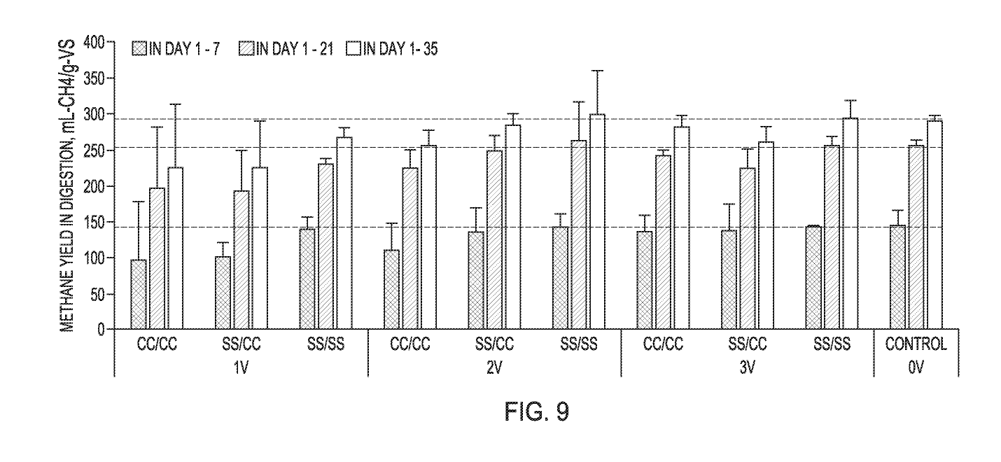

Intermittent voltage applications for 1 V, 2 V and 3 V voltages (15 min voltage application per day for 35 days) were then studied to improve the performance on hydrogen sulfide control and biogas generation by generating less amount of electrochemical intermediates. Results showed again that at the same electrode surface area, the combination of SS/CC and SS/SS was more effective than carbon cloth anode in hydrogen sulfide mitigation. At 3 V voltage at 25° C., the remaining hydrogen sulfide was only 3% and 7% of that of the control (from 427 to 12 and 30 ppmv), while at 35° C. hydrogen sulfide level was further decreased to 2% of the control (from 339 to 7 and 6 ppm). The application of 2 V voltage was less effective, but it still removed H₂S by 41% and 52% (250 and 206 ppmv) of at 25° C., and by 67% and 80% (67 and 110 ppmv) at the higher temperature (TABLE 3). The results for biogas generation was averaged for 25 and 35° C. (the control reactors at both temperatures generated biogas at similar rate, due to the high (40%) inoculum volatile solids addition), and also showed that methanogenesis underwent normally without abrupt interference in methane production in SS anode treatments, with methane contents between 70% and 80% of biogas volume. It was especially promising that the combination of SS/SS removed majority part of hydrogen sulfide at 2 and 3 V, and retained the capability for methane generation at both voltage levels FIG. 9 shows cumulated methane yields on day 7, 21, and 35 in dairy manure anaerobic digesters assisted with different levels of voltage. However, CC anode treatment yielded less methane than the control, which may be explained by the reactive oxygen species (e.g., free hydroxyl) generation that may oxidize organic matter and can be toxic to microorganisms when accumulated. Nevertheless, these results clearly demonstrated that by coupling AD with electrochemical oxidation process by suitable electrode materials, it will be feasible to mitigate biogas hydrogen sulfide level and meanwhile maintain methane production and yield in AD process.

TABLE 3
Cumulated hydrogen sulfide content (ppmv) in biogas on day 7, 21, and 35
at different applied voltages, temperatures, and electrodes combination

| | | 25° C., | 25° C., | 25° C., | 35° C., | 35° C., | 35° C., | | | |
|---|---|---|---|---|---|---|---|---|---|---|
| | | CC/CC | SS/CC | SS/SS | CC/CC | SS/CC | SS/SS | Control | 25° C. | 35° C. |
| 1 V | Day 7 | 700 | 500 | 500 | 300 | 400 | 300 | Day 7 | 500 | 350 |
| | Day 21 | 356 | 397 | 402 | 280 | 359 | 316 | Day 21 | 433 | 331 |
| | Day 35 | 340 | 397 | 393 | 277 | 358 | 318 | Day 35 | 427 | 339 |
| 2 V | Day 7 | 350 | 250 | 250 | 250 | 50 | 80 | | | |
| | Day 21 | 295 | 250 | 196 | 250 | 62 | 98 | | | |
| | Day 35 | 287 | 250 | 206 | 258 | 67 | 110 | | | |
| 3 V | Day 7 | 400 | 10 | 20 | 200 | 10 | 10 | | | |
| | Day 21 | 287 | 16 | 25 | 182 | 7 | 6 | | | |
| | Day 35 | 255 | 12 | 30 | 178 | 7 | 6 | | | |

The commonly adopted processes for biogas hydrogen sulfide removal is via the installation and operation of standalone facilities for biofilter and biotrickling oxidation, iron oxide/hydroxide adsorption, and liquid absorption. Adsorption using iron oxide has long been used in industry. This process is efficient but chemically intensive, and the adsorption media have to be replaced after utilization or after limited times of regeneration; otherwise, the performance starts declining due to elemental sulfur coverage on surface. The temperature of re-generation process needs to be well controlled to prevent ignition of the loading materials of wood chips because of the exothermic property of the conversion of iron sulfide to iron oxide. Additionally, the huge amount of spent solid waste that has to be processed and disposed is a concern. Biological processes, e.g., biofilters, biotrickling filters and bioscrubbers (fixed-film and suspended growth), offer cheaper options than chemical adsorption methods, but there are strict conditions to maintain those biological reactor performance by controlling dominating microorganism species and their activity, media nutrients level pH, oxygen level media recirculation, and gas and liquid flow velocity, which all add complexity to the upgrading systems.

Hydrogen sulfide removal from biogas is usually a prerequisite before biogas upgrading via processes such as pressure swing adsorption and water scrubbing because of its corrosive property and strong affinity to many adsorbents. It will be ideal that hydrogen sulfide is not emitted to biogas phase or is being mitigated during anaerobic digestion, so that biogas upgrading in terms of carbon dioxide will not be affected by the presence of hydrogen sulfide, not to mention the protective effects to digesters and pipes which are constantly subjected to the threats of sulfide. Therefore, different methods were proposed for in situ sulfide/hydrogen sulfide removal from reactor media. One benefit of the in situ sulfide removal is that no installation of an additional standalone cleaning unit for hydrogen sulfide is required, thus potentially reducing capital cost of overall AD facilities. Nitrate and nitrite dosing are used to couple sulfide oxidation, and iron salts dosing is another mitigation method that can scavenge sulfide to precipitate insoluble sulfide minerals. Electrochemical oxidation fulfills direct sulfide oxidation at anodes, potentially generates pure oxygen gas in situ, and does not introduce nitrogen to gas phase. The spatial distribution of electrodes via the adoption of low-cost materials can be designed in a way to decrease the mixing requirement as in micro-aeration. In high rate sulfide generation reactors where biological sulfide oxidation via oxygen gas does not go fast enough to remove sulfide, the release of metal ions from anode will have additional mitigating effects by rapidly binding sulfide to insoluble metal sulfide so that the mitigation effect will not be impaired. Future research is needed to elucidate those benefits, and it is also necessary to scale up the electrochemical oxidation method in order to assess the cost of electrode material maintenance and possible replacement.

### Example 3 Removal of Phosphorous from a Working Fluid

### Microbial Electrochemical Septic Tank Design

Microbial electrochemical septic tanks (MESTs) and septic tanks (STs) were made of low-density polyethylene (LDPE) material for the vessel. The vessels had capacity of 1 L volume. Both the ST and MEST reactors were assisted with stainless steel mesh of AISI 430, as for anode and cathode materials in the case of MEST. Six pairs of electrodes (4 cm×10 cm) were inserted to tank vessel, with a total and effective anode or cathode projected surface area of 240 cm². Electrode space in each pair of anode and cathode was minimized to 2 mm. Electrodes were glued to titanium wire with conductive epoxy, and connected to power supply for MESTs. Vessels were tested for air tightness and connected from lid to 3-L Tedlar gas sampling bags.

### Septic Tank Operation

All of the MESTs and STs were inoculated with anaerobic sludge and fed with sewage. The COD ratio of the inoculum and sewage was roughly 3:1 to guarantee a quick startup. Anaerobic sludge and raw sewage of before primary sedimentation were collected from Blue Lake Wastewater Treatment Plant located in Shakopee, Minn. Sewage, collected by three times, was frozen at −18° C. the same day of collection, and was defrosted at 4° C. before use. Raw sewage was filtered through sieves of open-pore size of 0.295 μm to remove sands and big chunks of garbage before being fed to reactors.

The first experiment was conducted to identify a range of applied voltage on MESTs that removed total phosphorus effectively while did not substantially increase volume of sludge that settle down to reactor bottoms. The ranged tested was between 0.25 V to 1.50 V with an increment of 0.25 V by assigning the voltage to each MEST reactor that was inoculated and fed with sewage (total liquid volume of 500 mL) as aforementioned and operated for 25 days at 15° C. Liquid was sampled every five days.

The second experiment was conducted to assess the MESTs (0.50, 0.63, 0.75, and 0.88 V) and STs (0 V) performance during 171-day operation at two temperatures of 25° C., and 15° C. The vessels were filled inoculated with anaerobic sludge and fed full with sewage to make a total liquid volume of approximately 1 L. The average hydraulic retention time (HRT) was 8.3 day with twice sampling/partial decanting (500 mL) events at each HRT. Liquid samples were carefully withdrawn with 50-mL syringe from the subsurface portion to avoid disturbance on the settled sludge and possible scum layers. To the contrary, mixed-liquor samples were obtained at the end of reactor operations by completely mixing reactor contents.

### Analytical Methods

Liquid samples of influent sewage and effluents were analyzed for its water characteristics, chemical oxygen demand, sulfate, total phosphorus (P), reactive P, total nitrogen (N), total ammoniacal nitrogen (TAN), and total iron (Fe) analysis by colorimetric methods using commercial testing kits (TNTplus™. Hach Company, Loveland. Colo.) with a UV-Vis spectrophotometer (Hach DR 5000) following the protocol for each assay. Before sulfate analysis, high purity chitosan powder of 0.3 g was added to samples of 10 mL to flocculate remaining solids for lower turbidity. Sulfide concentration was determined by ion-selective glass electrode (Cole Parmer, Chicago, Ill.) according to Standard Methods for the Examination of Water and Wastewater.

Total solids (TS) were quantified by overnight drying in oven at 105° C., and volatile solids (VS) by 30 min combustion in furnace at 550° C. Total suspended solids (TVS) and volatile suspended solids (VSS) were quantified with solids filtered through 0.45 μm glass fiber filter. Sludge volume of mixed-liquor was obtained by settling 100 mL liquid in 100 mL graduated cylinder. Sludge volume index (SVI) was calculated by dividing TVS by sludge volume.

Quasi-quantitative analysis for elemental composition of sludge, scum and electrode deposits from MESTs and ST at 25° C. were conducted through energy-dispersive X-ray spectroscopy (EDS). Corresponding solids were collected and dried at 60° C., followed by manual grinding with mortar and pestle. The microanalyzer JEOL 8900 was operated at 15 kV accelerating voltage and 5.5 nA probe current using a static focused beam. For each type of solid samples, three specimens were tested via element mapping at 100 μm sample scale. ANOVA and pairwise multiple comparisons based on Bonferroni test were conducted for total P concentration evolution with OriginPro Version 8 at significance level of α=0.05.

### Applicable Voltage Range

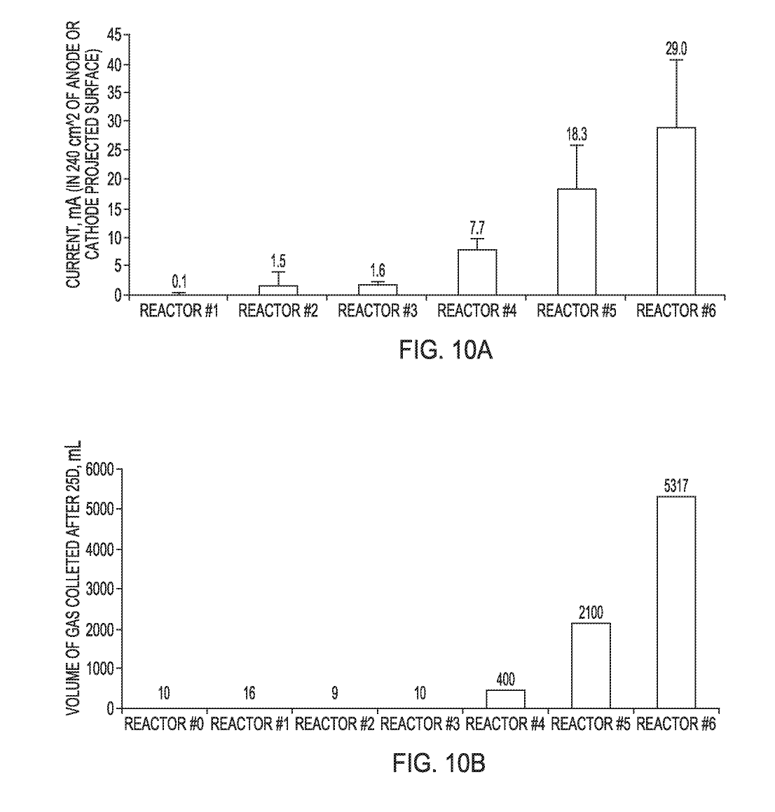

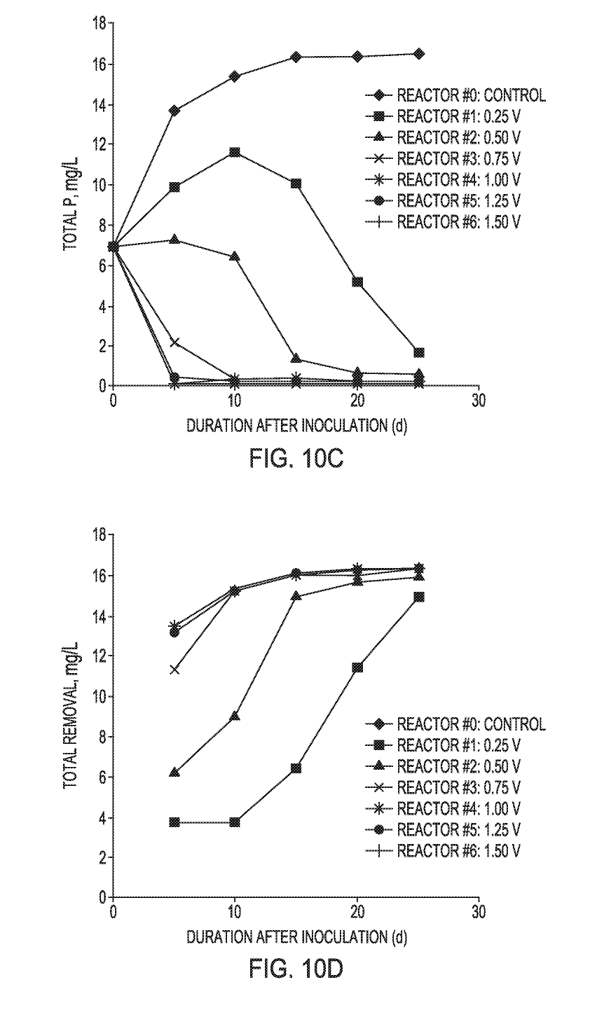

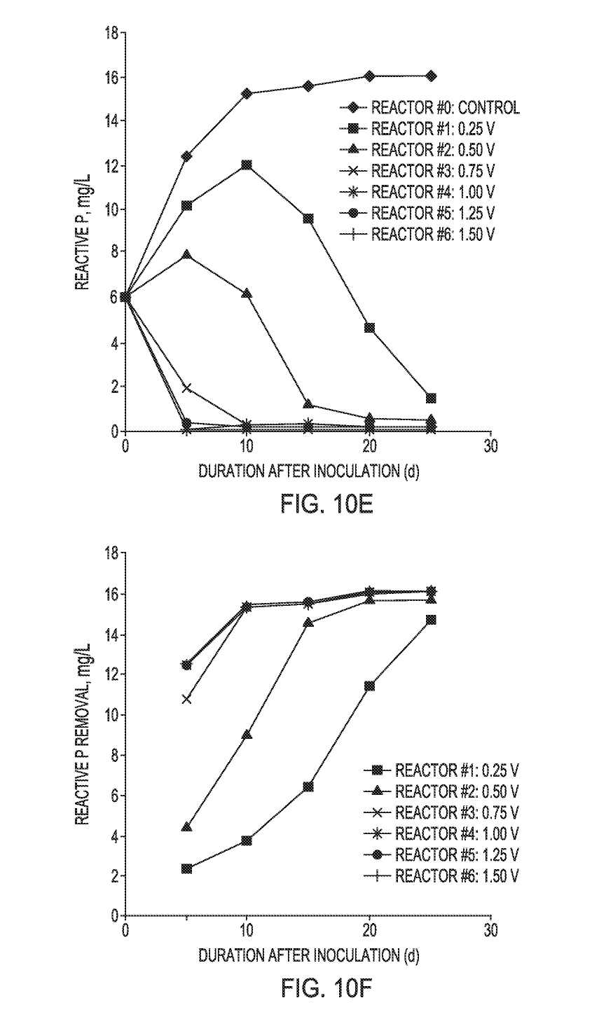

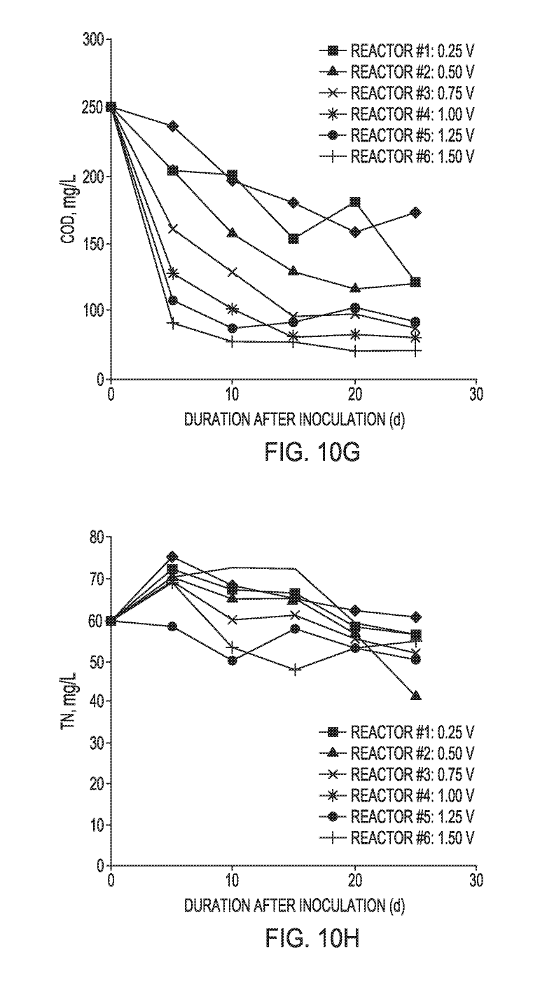

The reactors labeled from #0 to #6 corresponded to reactors of applied with a series of external voltages (#0, 0 V (control); #1, 0.25 V; #2, 0.50 V; #3, 0.75 V; #4, 1.00 V; #5, 1.25 V; #6, 1.50 V), respectively. The current passing through the anode and cathode was in an exponential relationship to the applied voltage, as shown in FIG. 10A. This relationship was found to be described by the equation of ln(I)=4.1665×Vₐₚ−2.4691 (R²=0.9327), where I is current in mA, and Vₐₚ is applied voltage. The biogas generated after 25 days of operation by these reactors is shown in FIG. 10B. As can be seen in FIG. 10B, biogas generation was negligible in Reactor #0 to #3 (e.g., 0 V to 0.75 V) due to limited availability of organic matter. When the applied voltage reached 1.00 V, non-microbial anode oxidation reactions (mainly metal oxidation to corresponding cations and thereafter water oxidation to oxygen gas) were coupled to cathodic water reduction to hydrogen gas.

FIGS. 10C-10F show the effect of the MEST reactors on phosphorous levels over time. FIG. 10C shows the total phosphorous level (“total P”) in the reactors; FIG. 10D shows the total phosphorous removal (“total P removal”) from the reactors; FIG. 10E shows the reactive phosphorous (“reactive P”) in the reactors; and FIG. 10F shows the reactive phosphorous removal (“reactive P removal”) from the reactors. Total P and reactive P of the control reactor #0 experienced a gradual increase and stabilized at 16.5 mg/L and 16.0 mg/L, as shown in FIGS. 10C and 10E, respectively. To the contrary. MEST reactors #1 to #6 all displayed substantial P removal from liquid phase, reaching total and reactive P levels of 1.65 mg/L and 1.45 mg/L, respectively, in Reactor #1 (0.25 V). It is apparent that all power assisted MEST reactors mitigated phosphorus from sewage, and that the removal rate relied on the applied voltage. For household sewage which has an entering total P level of approximately 10 mg/L and leaves an ST at a minimum hydraulic retention time (HRT) of 3 days, a complete P removal requires an average removal rate of 3.3 mg-P/L/day. Reactor #1 and #2 averaged removal rates of 0.75 and 1.25 mg-P/L/day (FIG. 10D). Starting at 0.75 V in Reactor #3, P removal capability was substantially improved. Reactive P removal followed the similar trend and also showed a drastic increase in Reactor #3 (FIG. 10F). It is therefore anticipated that under the given reactor configuration, voltages close to (marginally higher or lower than) 0.75 V could be an option for long-term evaluation because the power consumption was minimal, electrolysis was minimal, while the phosphorus removal efficiency from sewage could be promising. Based on this observation, it was decided to run long-term continuous operations for voltage levels between 0.5 V and 1.0 V, the results of which were shown in the next section. Conventional STs are regarded a primary treatment that functions for total suspended solids (“TSS”) and chemical oxygen demand (“COD)”, or more precisely, biochemical oxygen demand, or “BOD”) removal from sewage, but seldom works on N, P, and pathogenic microorganisms reduction. So occasionally, STs are modified to include effluent filter vault or complemented with an aerobic system for attached growth. In most situations, secondary treatment of sand filtration system is a must for conventional septic systems. The feature of MESTs for P removal in tanks therefore provides an important advantage over conventional STs. It was also seen that the removal of chemical oxygen demand (“COD”) and total nitrogen (“total N”) were both enhanced in MESTs over conventional STs, as shown in FIGS. 10G and 10F. Similar improvement in terms of COD removal was observed in a previous study using mixed metal oxides as anode material at water electrolysis conditions, which was attributed to electrolytic aeration in tanks for improved aerobic activities of microorganisms. Although the present inventors do not know the mechanisms for the MESTs described herein, the same explanation may be valid in MEST Reactors #4, #5, and #6 operated at 1.0, 1.25, and 1.50 V, which each had very high gas production.

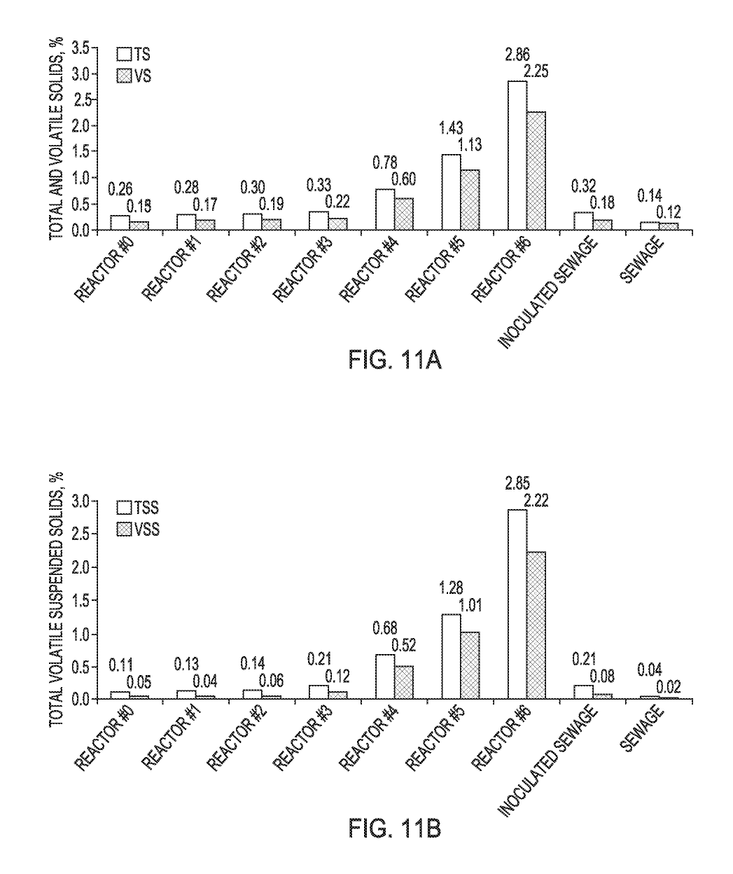

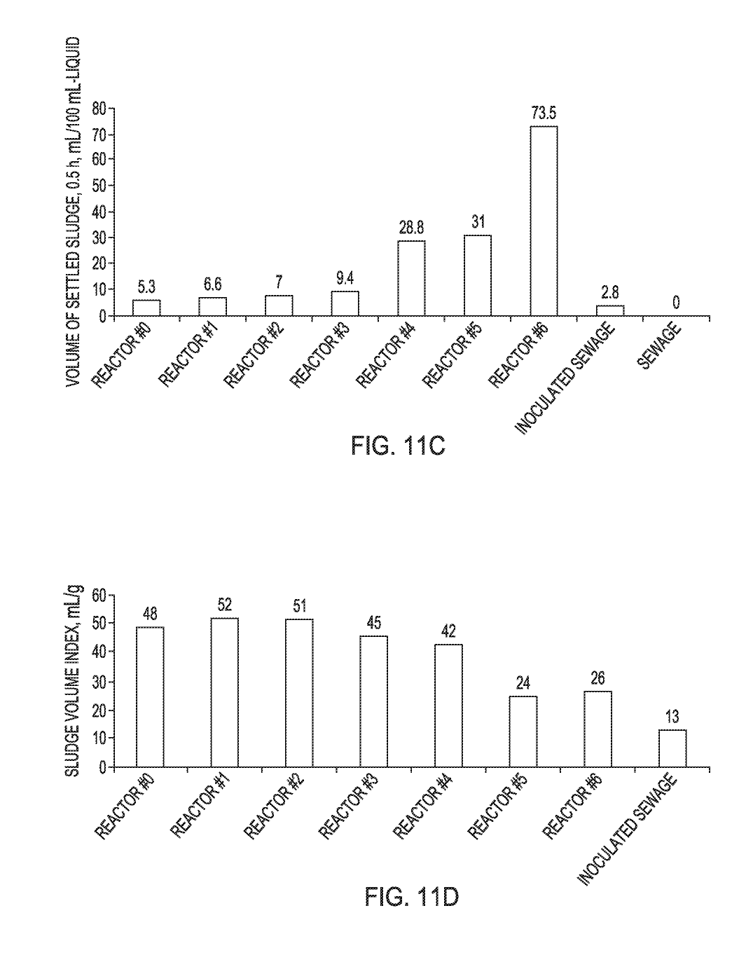

FIGS. 11A and 11B show values for the total solids (“TS”), volatiles solids (“VS”, total suspended solids (“TSS”), and volatile suspended solids (“VSS”) in mixed liquor samples at the end of the operation for each of the reactors, as well as in inoculated sewage and non-inoculated sewage. As can be seen in FIGS. 11A and 11B. TS, VS, TSS, and VSS values in the samples treated in the MEST reactors were slightly lower than or comparable to those of inoculated sewage. FIGS. 11A and 11B also show a slight increase in TS, VS, TSS, and VSS with an increase in the voltage applied to the MEST reactors until voltage reached 1.0 V (FIGS. 11A and 11I B). A more dramatic change occurred starting at an applied voltage of 1.0 V (Reactor #4), where TS. VS, TSS, and VSS increased by about 1.4, about 2.3, about 2.2, and about 5.5 folds compared to the inoculated sewage, respectively. The increase of various types of solids suggested metal oxidation and release of oxide and hydroxide particulates from the stainless steel anode at 1.0 V, such as oxidation of one or more of iron, nickel, chromium, and manganese. It is believed that the VS portion of the solids approximated to VSS that more likely was a result of dehydration of metal oxide and hydroxide particulates at 550° C. rather than from combustion of organic matter. It also appears that the anode metal release may have gradually increased sludge volume as shown in FIG. 11C, although the change of sludge volume index (“SVI”) was in a less degree as shown in FIG. 11D. Similar with solids contents, sludge volume experienced a sudden increase starting at 1.0 V (MEST Reactor #4). This increase in sludge may deteriorate normal operation of the septic tank due to excessive sludge accumulation, which further suggested an upper limit of 1.0 V for the applied voltage for the reactor configuration described and other conditions.

### Phosphorous Removal

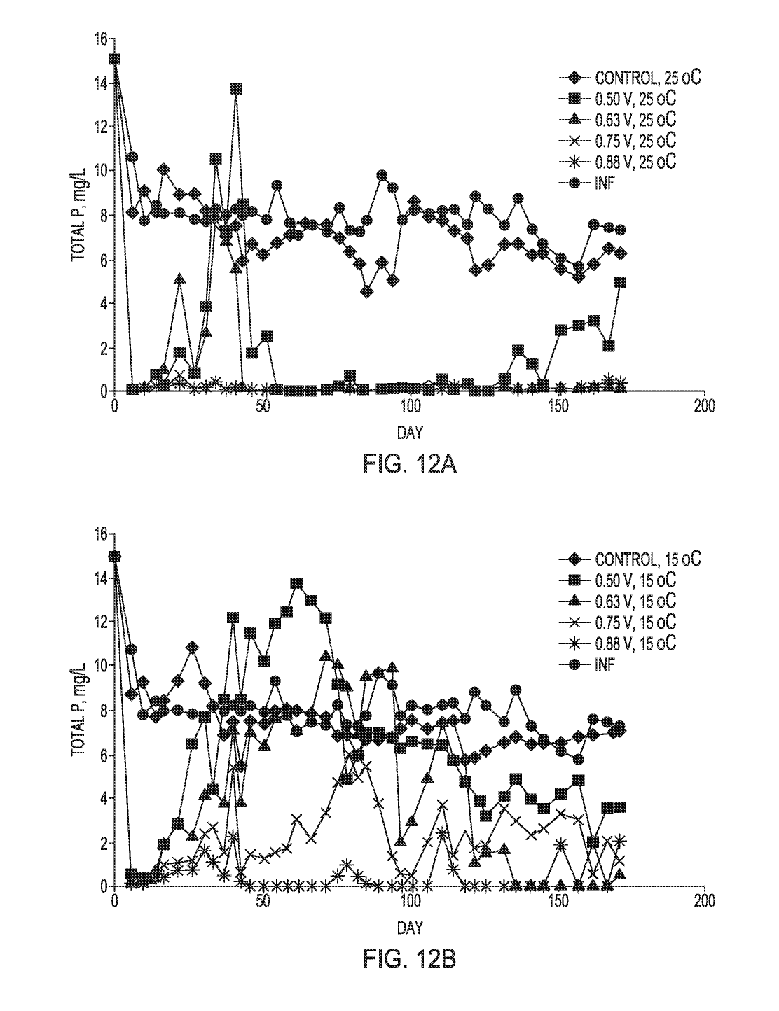

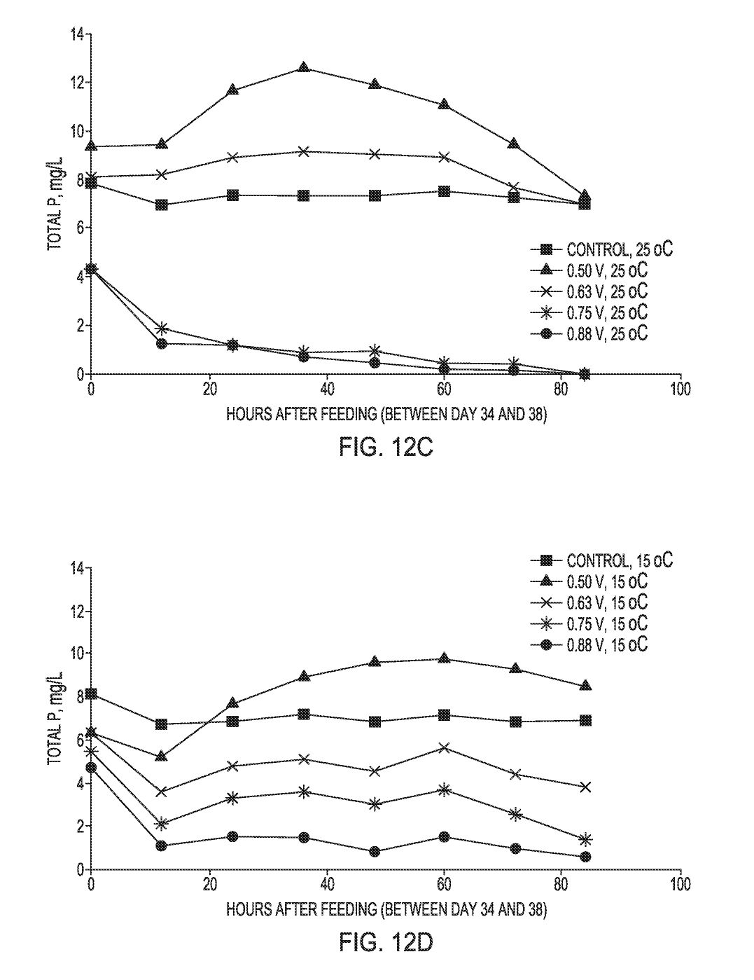

FIGS. 12A and 12B show the total phosphorous (“total P”) concentrations in the influent streams into and the effluent streams from the MESTs and STs. FIG. 12A shows the data at an operating temperature of 25° C. while FIG. 12B shows the data at an operating temperature of 15° C. A data summary as well as stepwise multiple comparisons results are presented in TABLE 4 below. Total P concentration of influent sewage over the time course averaged at 7.95±1.39 mg/L, and control reactors slightly removed phosphorus by natural settling of suspended solids and by floatation of scum. The results of effluent total P concentrations suggested that the novel design of microbial electrochemical configuration decreased total P concentration (p=0.0001) with an influence from temperature (p=0.0003), while the interaction of voltage and temperature was not significant (p=0.2723). Those performance differences in total phosphorus removal were elucidated by pairwise multiple comparisons given in Error! Reference source not found. 4. It can be concluded that at 25° C., 0.63 V or higher voltage at the selected electrode material was practically effective to remove the most total phosphorus from sewage (i.e., >89.7%), resulting in an effluent total P concentration of less than 0.82 mg/L over the 171 days of operation. At 15° C., phosphorus removal efficiency was smaller such that 0.88 V was found to be needed to remove over 90% of the total phosphorus from sewage. FIGS. 12C and 12D show the total P concentration evolution in a typical cycle as compared to the data of FIGS. 12A and 12B. FIG. 12C shows the total P evolution at an operating temperature of 25° C., while FIG. 12D shows the total P evolution at an operating temperature of 15° C. FIGS. 12C and 12D suggest a relatively high rate of P removal in the first 12 hours followed by a slower removal or stabilized P content thereafter. This behavior of P evolution suggested that it is possible to decrease hydraulic retention time (HRT) to a typical ST operation of 3 days while the P removal efficiency is maintained at a similar level.

TABLE 4
Summary of total phosphorus concentrations in influents and effluents
of different reactors

| | | | | Stepwise multiple |
|---|---|---|---|---|
| | Total P, avg. | SD | Removal | comparisons based on |
| | mg/L | mg/L | % | Bonferroni test* |
| Influent | 7.95 | 1.39 | — | |
| Control, 25° C. | 6.98 | 1.72 | 12.2 | a |
| 0.50 V, 25° C. | 1.81 | 3.67 | 77.2 | cd |
| 0.63 V, 25° C. | 0.82 | 2.92 | 89.7 | cde |
| 0.75 V, 25° C. | 0.14 | 2.30 | 98.3 | e |
| 0.88 V, 25° C. | 0.11 | 2.31 | 98.7 | e |
| Control, 15° C. | 7.36 | 1.60 | 7.45 | a |
| 0.50 V, 15° C. | 6.30 | 3.84 | 20.7 | a |
| 0.63 V, 15° C. | 4.31 | 3.90 | 45.8 | b |
| 0.75 V, 15° C. | 2.26 | 2.48 | 71.6 | c |
| 0.88 V, 15° C. | 0.49 | 2.36 | 93.9 | de |

*Treatments sharing a same letter(s) are not significantly different at the significance level of α = 0.05.

It was also observed that total P contents in effluents of most treatments (except at 0.75 and 0.88 V at 25° C., and at 0.88 V at 15° C.) fluctuated at some periods of time although the contents of influent P and effluent P in control reactors were quite stable. For example, at 15° C. lower voltage experienced earlier and larger fluctuations of P content (FIG. 12B). The reason remained unclarified, but it was possible that microbial sulfate reduction and formation of sulfide may compete with phosphate ion for iron binding at this high influent sulfate concentration of 0.78 mM (25 mg SO₄²⁻-S/L), which is one of the mechanisms for phosphorous removal, and release phosphate from sludge to liquid phase.

The energy cost for treating one cubic meter of sewage by METSs is summarized in Error! Reference source not found., While the conventional STs did not consume energy, these tanks only removed marginal portion of P. By using MESTs, the energy cost ranged between $0.06 and 4.46/m³-sewage at 25° C., and between $0.03 and 2.83/m³-sewage at 15° C. From the point view of treatment cost, 0.63 V at 25° C., and 0.75 V at 15° C. were more cost effective, and meanwhile achieved 89.7% and 71.6% of total P removal.

TABLE 5
Energy cost for treatment by METSs.

| | Anode or | | | | | Treatment | Treatment |
|---|---|---|---|---|---|---|---|
| | cathode | Anode | Cathode | | | energy | energy |
| | projected | potential | potential | | Power | consumption | cost |
| | surface area | mV vs. | mV vs. | Current | mW/L- | kWh/m\hat{ }3- | $/m\hat{ }3- |
| | cm\hat{ }2/L | Ag/AgCl | Ag/AgCl | mA | tank | sewage | sewage* |
| Control, 25° C. | | −481 ± 80 | −481 ± 80 | 0 ± 0 | 0 | 0.00 | 0.00 |
| 0.50 V, 25° C. | | −213 ± 123 | −713 ± 123 | 5 ± 4 | 3 | 0.52 | 0.06 |
| 0.63 V, 25° C. | | −101 ± 175 | −731 ± 175 | 13 ± 10 | 8 | 1.67 | 0.20 |
| 0.75 V, 25° C. | | −11 ± 107 | −761 ± 107 | 142 ± 33 | 107 | 21.27 | 2.55 |
| 0.88 V, 25° C. | 240 | −23 ± 72 | −903 ± 72 | 212 ± 61 | 186 | 37.14 | 4.46 |
| Control, 15° C. | | −485 ± 38 | −485 ± 38 | 0 ± 0 | 0 | 0.00 | 0.00 |
| 0.50 V, 15° C. | | −266 ± 101 | −766 ± 101 | 3 ± 1 | 1 | 0.26 | 0.03 |
| 0.63 V, 15° C. | | −205 ± 105 | −835 ± 105 | 12 ± 3 | 8 | 1.53 | 0.18 |
| 0.75 V, 15° C. | | −70 ± 76 | −820 ± 76 | 22 ± 22 | 17 | 3.34 | 0.40 |
| 0.88 V, 15° C. | | 17 ± 81 | −864 ± 81 | 134 ± 101 | 118 | 23.56 | 2.83 |

*Treatment cost was estimated at an energy cost of $0.12/kWh.

The P removal method in this study by MESTs is promising from many perspectives compared to previously proposed methods. Steel slag (CaO—MgO-SiO2-FeO quaternary system), a byproduct from the conversion of scrap/iron to steel, was packed to filter for recirculation and tested as an inexpensive material for P removal. The steel slag filter achieved 4.2 mg-P/L at the effluent for total P (pH 8.8), which required a further treatment. Amorphous ferric-(oxide)-hydroxide (a-FeOOH), a chemical prepared from ferric chloride solution with pH adjustment to a pH of 7 with NaOH solution, was tested as an additive to sewage for P removal. The mineral was first partially reduced and dissolved by microbial iron-reducing bacteria to ferrous iron when carbon source was available, and the soluble Fe functioned to immortalize phosphate by formation of vavianite (Fe₃(PO₄)₂). Total P was nearly completely removed from synthetic sewage (total P of 28.5 mg/L) when iron additive reached a molar ratio of 3:1 for Fe/P, but one consequence was that the effluent Fe concentration reached to 53 mg/L. In order to maintain good performance, the reactor content was stirred by mixing blade, otherwise the P removal decreased to 70%. The reactor was operated under anaerobic sequencing batch mode for good performance, and the settled sludge will have to be periodically withdrawn from the reactor. Electrode metal addition was proposed in an impending patent application; however, the performance data of the technology were not given and thus impossible to compare with the current study. The use of mild steel (low carbon steel) in that study rather than stainless steel may risk the anode under an increased tendency of corrosion, and the energy from microbial oxidation was not harnessed.

### Phosphorous Balance

Phosphorus in influent wastewater, in sludge of the septic tanks, in effluent, and the balance are listed in TABLE 6. These data showed the possibility that the 0.50 V and 0.63 V treatments accumulated more P in electrode deposits and scums than that of higher voltage treatments of 0.75 and 0.88 V; however, these two portions of deposits and scums were not separately quantified in current study and the amounts of P in each portion remained unknown.

TABLE 6
Phosphorus balance in different reactors (25° C.)

| | | | | P on electrodes |
|---|---|---|---|---|
| | Amt. of | | Amt. P in | and scum |
| | eff P | Amt. P removed | Sed | (the balance) |
| | mg | mg | mg | mg |
| Influent | 178 | — | — | — |
| Control, 25° C. | 143 | 35 | 13 | 21 |
| 0.50 V, 25° C. | 37 | 141 | 26 | 114 |
| 0.63 V, 25° C. | 17 | 161 | 37 | 125 |
| 0.75 V, 25° C. | 3 | 175 | 92 | 83 |
| 0.88 V, 25° C. | 2 | 176 | 92 | 83 |

### Other Wastewater Parameters

Other wastewater parameters of the influents and effluents were listed in Error! Reference source not found. 7 Total COD of the influent sewage was 359±118 mg/L on average, and was decreased to between 97 and 107 mg/L at 25° C., and to between 102 to 123 mg/L at 15° C. Therefore, no substantial improvement on COD removal via MEST treatments was noticed as in the voltage screening experiment which covered a wider voltage range of up to 1.50 V. TS was slightly removed from sewage, and TSS was substantially removed; however, it seemed a minor trend that voltages over 0.63 V resulted in a marginal increase compared to the 0.5 V treatment and the control at both temperatures. Similar minor effect of voltage was also observed for VS and VSS. Ammonium N slightly increased in all treatments compared to that of the influent (35.1±1.4 mg/L), which was a result of organic nitrogen mineralization and nitrate reduction. The organic N, regarded as the difference between total N and TAN, was accordingly decreased from 14±3.6 mg/L in influent sewage to between 0.6 and 3.4 mg/L at 25° C., and to between 2.4 to 3.8 mg/L at 25° C.

TABLE 7
Wastewater characteristics of influents and effluents of different MESTs

| | COD | TS | VS | TSS | VSS | TAN | TN*** | Organic N | Sulfate |
|---|---|---|---|---|---|---|---|---|---|
| | (n = 10), | (n = 3) | (n = 3) | (n = 3) | (n = 3) | (n = 5) | (n = 5) | (n = 5) | (n = 5) |
| | mg/L | mg/L | mg/L | mg/L | mg/L | mg/L | mg/L | mg/L | mM |
| Influent | 359 ± 118 | 1552 ± 58 | 262 ± 23 | 197 ± 46 | 65 ± 30 | 35.1 ± 1.4 | 49.2 ± 3.5 | 14 ± 3.6 | 0.78 ± 0.09 |
| Control, 25° C. | 106 ± 40 | 1370 ± 40 | 103 ± 55 | 7 ± 12 | 0 ± 0 | 43.2 ± 2 | 45.5 ± 2.3 | 2.2 ± 2.4 | 0.17 ± 0.09 |
| 0.50 V, 25° C. | 97 ± 17 | 1340 ± 53 | 150 ± 26 | 0 ± 0** | 10 ± 17 | 37.8 ± 7.5 | 41.1 ± 7.5 | 3.4 ± 2.6 | 0.09 ± 0.03 |
| 0.63 V, 25° C. | 98 ± 19 | 1287 ± 107 | 140 ± 50 | 33 ± 58 | 37 ± 32 | 42 ± 5.1 | 42.6 ± 5.2 | 0.6 ± 0.9 | 0.04 ± 0.01 |
| 0.75 V, 25° C. | 107 ± 47 | 1230 ± 35 | 160 ± 36 | 30 ± 26 | 33 ± 35 | 39.7 ± 2.9 | 41.2 ± 3.9 | 1.5 ± 1.6 | 0.08 ± 0.02 |
| 0.88 V, 25° C. | 103 ± 20 | 1177 ± 86 | 173 ± 21 | 33 ± 29 | 50 ± 70 | 40.9 ± 4.6 | 41.5 ± 4.9 | 0.6 ± 0.8 | 0.05 ± 0.01 |
| Control, 15° C. | 123 ± 32 | 1360 ± 31 | 132 ± 38 | 7 ± 6 | 15 ± 26 | 41.5 ± 4.1 | 45 ± 5.3 | 3.6 ± 2.4 | 0.10 ± 0.02 |
| 0.50 V, 15° C. | 112 ± 46 | 1293 ± 21 | 127 ± 12 | 0 ± 0 | 20 ± 20 | 37.8 ± 6.1 | 40.5 ± 6.9 | 2.7 ± 1.6 | 0.26 ± 0.08 |
| 0.63 V, 15° C. | 111 ± 33 | 1290 ± 36 | 140 ± 44 | 23 ± 21 | 37 ± 35 | 40.9 ± 5 | 43.2 ± 6 | 2.4 ± 1.9 | 0.08 ± 0.03 |
| 0.75 V, 15° C.* | 104 ± 24 | 1380 ± 13 | 178 ± 10 | 58 ± 101 | 47 ± 45 | 38.7 ± 5.6 | 42.4 ± 6 | 3.7 ± 2 | 0.09 ± 0.03 |
| 0.88 V, 15° C.* | 102 ± 26 | 1325 ± 44 | 158 ± 38 | 23 ± 40 | 15 ± 22 | 37.8 ± 5.2 | 41.6 ± 4.6 | 3.8 ± 1.7 | 0.07 ± 0.01 |

| | | | | Total | | |
|---|---|---|---|---|---|---|
| | Sulfide | TP | RP | iron | pH | ORP |
| | (n = 5) | (n = 41) | (n = 7) | (n = 6) | (n = 2) | (n = 2) |
| | mM | mg/L | mg/L | mg/L | — | mV |
| Influent | 0.01 ± 0.01 | 7.95 ± 1.39 | 6.29 ± 0.82 | 2.05 ± 0.25 | 7.03 ± 0.04 | −237 ± 15 |
| Control, 25° C. | 0.17 ± 0.10 | 6.98 ± 1.72 | 6.93 ± 0.65 | 0.3 ± 0.55 | 7.17 ± 0.06 | −250 ± 12 |
| 0.50 V, 25° C. | 0.00 ± 0.00 | 1.81 ± 3.67 | 2.31 ± 4.11 | 5.48 ± 3.42 | 7.25 ± 0.04 | −74 ± 44 |
| 0.63 V, 25° C. | 0.00 ± 0.00 | 0.82 ± 2.92 | 0.09 ± 0.15 | 2.22 ± 3.34 | 8.99 ± 0.19 | −79 ± 31 |
| 0.75 V, 25° C. | 0.00 ± 0.00 | 0.14 ± 2.3 | 0.07 ± 0.13 | 2.93 ± 5.42 | 9.23 ± 0.09 | −56 ± 9 |
| 0.88 V, 25° C. | 0.00 ± 0.00 | 0.11 ± 2.31 | 0.03 ± 0.08 | 2.5 ± 3.31 | 9.17 ± 0.23 | −31 ± 23 |
| Control, 15° C. | 0.06 ± 0.04 | 7.36 ± 1.6 | 6.78 ± 0.19 | 0.32 ± 0.32 | 7.04 ± 0.06 | −251 ± 21 |
| 0.50 V, 15° C. | 0.04 ± 0.04 | 6.3 ± 3.84 | 5.77 ± 3.36 | 0.38 ± 0.41 | 7.04 ± 0.05 | −225 ± 17 |
| 0.63 V, 15° C. | 0.01 ± 0.01 | 4.31 ± 3.9 | 4.05 ± 4.04 | 5.98 ± 6.47 | 7.01 ± 0.09 | −110 ± 22 |
| 0.75 V, 15° C.* | 0.00 ± 0.00 | 2.26 ± 2.48 | 2.52 ± 1.47 | 5.79 ± 5.75 | 7.13 ± 0.15 | −129 ± 41 |
| 0.88 V, 15° C.* | 0.00 ± 0.00 | 0.49 ± 2.36 | 0.52 ± 0.81 | 5.87 ± 5.55 | 7.46 ± 0.13 | −183 ± 18 |

*These two treatments have 2 × n measurements because of two replicates runs.
**Values of means of 0, 0.0, or 0.00 indicate levels less than detection limits of methods.
***Nitrite and nitrate were excluded from reporting because of their negligible levels: influent consistently contained 1.0%-1.2% of total N as nitrite/nitrate-N, and effluents contained 0.37% of N as nitrite/nitrate-N on average.

Sulfate content in influent sewage averaged at 0.78±0.09 mM, and was decreased to 0.17±0.09 mM and 0.10±0.02 mM in control reactors at 25 and 15° C., respectively. Sulfide content was accordingly increased to 0.17±0.10 mM and 0.06±0.04 mM in the control reactors. MESTs completely removed the biologically generated sulfide, resulting in sulfide content of less than detecting limit of 1 μM (or 0.001 mM) under all treatments at 25° C. At 15° C., sulfide content averaged at 0.04 and 0.01 mM at 0.50 and 0.63 V, respectively, and was eliminated with higher voltages of 0.75 and 0.88 V. Sludge and other solids composition analysis indicated the formation of oxidized sulfur species like elemental sulfur at 0.50 V, and the formation of iron-sulfide precipitates in all treatments. The presence of total iron in effluents of voltage treated reactors suggested the possibility of this chemical binding, and the dark color of those effluents also evidenced the presence of particulates of ferrous sulfide species due to their extremely small solubility product constants. This property of MESTs may be utilized to control hydrogen sulfide, the protonated sulfide species, which is one of the major culprits for odor emission. MESTs may also protect tanks from corrosion when tanks are made from materials that tend to under sulfide attacking.

### Example 4: Bench-Scale Test in Swine Manure Storage

An experiment was conducted to decrease the concentration of hydrogen sulfide (H₂S) inside swine manure storage simulated in 0.5 or 1 L polypropylene bottles for jar testing.

A set of laboratory-scale, short-term experiments were conducted to study the sulfide removal kinetics from the simulated swine manure storage apparatus with sulfide spiked in manure. The experiment was conducted in 0.5 L polypropylene bottles filled with 400-mL swine manure spiked with varying levels of sulfide. Each test lasted for 9-18 days depending on the experimental conditions under evaluation, with liquid sampled and analyzed at 1, 2, or 3 days' interval to determine sulfide concentration, pH, conductivity, oxidation/reduction potential, and to analyze the headspace gas. Operating parameters that were evaluated included: the material combination of the two electrode materials (stainless steel 304 (SS304) and low carbon steel (LCS)); voltage ranges (0.8-3.0 V and 0.3-1.0 V for the two electrode materials, respectively); electrode surface areas (18.9, 15.12, 11.34, 7.44, and 3.78 cm²/400-mL manure); total solids content in the manure (0.2%, 1%, 2%, 4% and 6%); initial sulfide content in the manure (2, 3, 5, and 8 mM); and storage temperatures (4, 20, and 30° C.). The experiments found that SS304 electrodes started to remove sulfide when voltage was higher than 1.2 V, but electrode corrosion was substantial during treatment. LCS electrodes showed sulfide removal at much lower voltage (e.g., 0.35 V), and was more suitable because corrosion of the LCS electrodes was more controllable under a wider range of applied voltage. The experiments also found that higher surface area seemed to remove sulfide at a higher rate, while the smallest surface area (3.78 cm²/400-mL manure) removed 94% of sulfide in 9 days. The experiments found that total solids content did not show substantial effect on sulfide removal rate. The experiments also found that the percentage removal of sulfide was negatively related to the initial sulfide content. The experiments found that over 85% of sulfide can be removed during 9 days of storage within a temperature range of from about 4° C. to about 30° C. The present inventors believe that treatment with LCS at 0.7 V can be potentially applied to real manure storage to achieve a satisfactory sulfide removal in the duration of between 10 to 20 days.

A further long-term storage experiment was conducted to evaluate the treatment technology in the manure storage apparatus with sulfide produced by natural microbial activities of degradation. Seven electrode materials were evaluated in 1-L polypropylene bottles: low carbon steel (LCS), stainless steel 304 (SS304), stainless steel 316 (SS316), stainless steel 430 (SS430), copper 110 (Cu110, over 99% copper), plain carbon cloth (PCC), and a dimensionally stable mixed metal oxides (MMO). The applied voltage for the seven electrode materials were as follows: LCS, 0.20 V; SS304. SS316 and SS430, 1.0 V; Cu110, 0.75 V; PCC and MMO, 1.70 V. Each voltage was chosen to minimize or prevent loss of electrode material but also to provide for as much sulfide removal as possible. After 74 days of storage, the treatment under the above-mentioned condition achieved H₂S removal efficiencies (when compared to the headspace H₂S level in the control storage, which was 240 ppm) of 0.6% (LCS), 100% (SS304), 7.3% (SS316), 100% (SS430), 96.1% (Cu110), 63% (PCC), and 100% (MMO). At 74 days, the liquid manure in all storage was spiked with 32 mg-sulfide/L, and the voltage was changed to: LCS, 0.20 V; SS304, SS316 and SS430, 1.3 V; Cu110, 0.75 V; PCC 2.6 V; and MMO, 2.0 V. Thereafter, 10 days treatment achieved removal efficiencies of 43.7% (LCS), 100% (SS304), 72.5% (SS316), 99.7% (SS430), 73% (Cu110), 19.3% (PCC), and 98.1% (MMO). This experiment confirmed that SS304 was a suitable electrode material at a voltage of 1.3 V and LCS would require a voltage of higher than 0.2 V to have substantial performance. MMO can be effective as well despite its high cost, and Cu110 was acceptable.

### Example 5: Pilot-Scale Test in a Swine Barn

Based on the operating parameters obtained in the lab-scale experiment of Example 4, an electrochemical treatment device was designed and installed in two manure pump-out accesses in a testing barn that held about 200 growing-finishing pigs. Each pit access was divided to two compartments, one compartment as a control and the other as a treatment installation. Perforated sheets of two electrode materials of low carbon steel (LCS) and stainless steel Type AISI 304 (SS) were installed in accesses and tested for 97 days in total. A mobile lab was located in field, housing a gas sampling system, gas analyzers, computers, data acquisition systems, calibration gas cylinders, and other supplies. H₂S was measured via TEI Model 45C of a pulsed fluorescence SO₂ detector with H₂S—SO₂ converter. The voltage was set up at 0.63 V between days 0 to 76, and was increased to 0.67 V between days 77 to 92, yielding a current of 0.14 A and 0.26 A, respectively. In the SS treatment, due to the decrease of internal resistance as a result of increased catalytic effect on oxidation/reduction reactions, the same voltage application of 1.3 V yielded 0.047 A during days 0 to 50, and 0.18 A during days 78 to 92. LCS treatment removed 56%-78% of H₂S, and SS treatment removed 13%-38% of H₂S. LCS treatment required a lower voltage application and achieved better removal performance, and therefore it was determined that LCS was a more suitable material for the purpose of H₂S control.

A techno-economic assessment was conducted for the treatments set up and tested in the swine barn (TABLE 8). It was assumed that the full installation was implemented in a typical deep-pit swine barn that houses 2400 pigs, that both the barn and treatment devices had a 20-year service lifetime, and that the annual interest rate was 8%. The electrode material cost was based on quotations from vendors. The result was an estimated Net Present Cost of about $135,000 for the LCS installation, and about $219,000 for the SS installation. The cost accounted for 16% and 26% of barn construction cost, equivalent to an additional cost of about $0.94/pig and $1.52/pig, respectively.

TABLE 8
Installation and operating cost for electrochemical sulfide device in a typical 2400-pig
twin barn: two treatments with the observed removal efficiency based on low carbon steel and
stainless steel, respectively

| Full installation | LCS, $ | SS, $ | Assumptions |
|---|---|---|---|
| Electrode material | 33464 | 115093 | 20-yr operation |
| Power supply | 18202 | 18202 | GEN30-500 |
| Wire, tape, wood, shelf, | 51161 | 51161 | Estimated from pilot-scale test with 10 times |
| etc., misc | | | saving |
| Labor in skid preparation | 7200 | 7200 | 30 working days |
| Labor in installation | 4800 | 4800 | 10 working days; 2 ppl |
| Total capital cost | 114828 | 196456 | |
| Labor in maintenance in 1 yr | 1440 | 1440 | Half day visit per month |
| Power cost in 1 yr | 679 | 911 | Continuous voltage application |
| Total annual O&M cost | 2119 | 2351 | |
| Net Present Cost | 135635 | 219538 | Assuming 20 yrs operation and 8% I; (P/A, |
| | | | 8%, 20), 9.8181 |
| Uniform amount per year | 13821 | 22371 | Assuming 20 yrs operation and 8% I; (A/P, |
| | | | 8%, 20), 0.1019 |

### Example 6: Pilot-Scale Installation in Wastewater Collection and Treatment Units

The electrochemical treatment unit of Examples 4 and 5 was installed inside a pilot-scale 100-gal wastewater handling and treatment unit. The performance demonstrated the technology application in close-to-real operating conditions of typical septic tanks in, for example, Minnesota, or in municipal wastewater collection systems, for example, in sewer or lift stations. Five treatment conditions were assessed—i.e., the control condition, a full load of electrodes with a voltage application of 0.82 V, 1.1 V and 1.3 V, and a half-load of electrodes with 1.3 V voltage. Total phosphorus removal efficiency of −14.9%, 28.2%, 38.5%, 42.9% and 34.2% were achieved, respectively. Compared with the influent, the effluent had generally both sulfide and hydrogen sulfide removal (TABLE 9). The equilibrium sulfide removal efficiency was 54%, 76.6%, 85%, and 93.5%, respectively. An economic assessment on the technology installation and operation was conducted based on the inputs from the pilot-scale experiment. The average net present cost for a 1000-gal septic tank for 30 years in Minneapolis, Minn, area is $7,795, and the estimated replacement cost of a conventional septic tank with a microbial electrochemical septic tank increased the cost by about 37%, with an estimated net present cost of $10,661. When the alternative system was powered by solar panel, the net present cost was estimated at $10,345, or about a 33% increase from the cost of a conventional septic system. The demonstration also showed this technology can be used in municipal wastewater collection system such as in sewer or lift stations.

TABLE 9
Typical Wastewater Characteristics of Septic Tank Influent and Effluent Treated at Various Conditions

| | Phase 1, day 15-30, | | | Phase 2, day 41-58, | | | Phase 3, day 65-82, | | |
|---|---|---|---|---|---|---|---|---|---|
| | control | | | 0.82 V | | | 1.1 V | | |
| Characteristics | Inf | Eff | RE, % | Inf | Eff | RE, % | Inf | Eff | RE, % |
| pH | 7.36 ± 0.3 | 7.31 ± 0.18 | | 7.34 ± 0.25 | 7.26 ± 0.13 | | 7.24 ± 0.11 | 7.1 ± 0.11 | |
| Conductivity, μS/cm | 1232 ± 144 | 1241 ± 159 | | 1425 ± 70 | 1470 ± 55 | | 1493 ± 105 | 1525 ± 31 | |
| Sulfide, mg/L | 1.79 ± 2.95 | 0.32 ± 0.29 | 82 | 1.85 ± 1.48 | 0.85 ± 1.44 | 54 | 3.75 ± 5.44 | 0.88 ± 1.48 | 77 |
| H2S, calc, ppm | 171 ± 300 | 32 ± 31 | 81 | 175 ± 150 | 66 ± 82 | 62 | 561 ± 1081 | 156 ± 352 | 72 |
| TS, mg/L | 1095 ± 189 | 1040 ± 247 | 5 | 1082 ± 164 | 895 ± 95 | 17 | 980 ± 89 | 863 ± 82 | 12 |
| TDS, mg/L | 981 ± 191 | 985 ± 243 | 0 | 980 ± 151 | 830 ± 117 | 15 | 915 ± 54 | 825 ± 76 | 10 |
| TSS, mg/L | 124 ± 36 | 55 ± 21 | 55 | 109 ± 53 | 73 ± 62 | 33 | 104 ± 33 | 49 ± 14 | 53 |
| TP, mg/L | 5.79 ± 1.74 | 6.65 ± 0.47 | −15 | 6.74 ± 1.85 | 4.84 ± 1.79 | 28 | 6.9 ± 1.06 | 4.24 ± 0.43 | 39 |
| tDP, mg/L | 3.16 ± 0.81 | 4.78 ± 0.91 | −51 | 4.11 ± 1.15 | 2.78 ± 1.23 | 32 | 4.53 ± 1.01 | 3.29 ± 0.17 | 27 |
| tSP, mg/L | 2.63 ± 1.72 | 2.27 ± 1.71 | 14 | 2.63 ± 1.38 | 2.05 ± 0.71 | 22 | 2.37 ± 0.65 | 0.95 ± 0.47 | 60 |
| RP, mg/L | 3.57 ± 0.87 | 5.78 ± 0.75 | −62 | 5.81 ± 2.37 | 4.01 ± 0.83 | 31 | 5.62 ± 1.16 | 3.9 ± 0.45 | 31 |
| tCOD, mg/L | 398 ± 112 | 199 ± 36 | 50 | 436 ± 149 | 163 ± 28 | 63 | 422 ± 85 | 186 ± 24 | 56 |
| sCOD, mg/L | 156 ± 38 | 115 ± 31 | 26 | 168 ± 23 | 89 ± 29 | 47 | 179 ± 24 | 72 ± 22 | 60 |
| NH4—N, mg/L | 20 ± 4 | 24 ± 7 | −22 | 27 ± 6 | 37 ± 11 | −38 | 33 ± 4 | 41 ± 5 | −23 |

| | Phase 4, day 83-98, | | | Phase 5, day 99-113, | | | Phase 6, day 114-35, | | |
|---|---|---|---|---|---|---|---|---|---|
| | 1.3 V | | | 1.3 V, half electrodes | | | control | | |
| Characteristics | Inf | Eff | RE, % | Inf | Eff | RE, % | Inf | Eff | RE, % |
| pH | 7.28 ± 0.15 | 7.19 ± 0.22 | | 7.37 ± 0.08 | 7.31 ± 0.21 | | 7.22 ± 0.13 | 7.24 ± 0.19 | |
| Conductivity, μS/cm | 1309 ± 95 | 1295 ± 117 | | 1436 ± 79 | 1437 ± 71 | | 1448 ± 87 | 1564 ± 59 | |
| Sulfide, mg/L | 1.23 ± 1.07 | 0.19 ± 0.12 | 85 | 4.13 ± 3.16 | 0.27 ± 0.1 | 94 | 10 ± 20 | 4 ± 5 | 61 |
| H2S, calc, ppm | 123 ± 120 | 21 ± 14 | 83 | 362 ± 298 | 25 ± 14 | 93 | 937 ± 1574 | 372 ± 443 | 60 |
| TS, mg/L | 1007 ± 118 | 776 ± 180 | 23 | 985 ± 115 | 887 ± 55 | 10 | 1149 ± 394 | 1036 ± 60 | 10 |
| TDS, mg/L | 864 ± 94 | 718 ± 174 | 17 | 858 ± 129 | 848 ± 49 | 1 | 971 ± 396 | 940 ± 51 | 3 |
| TSS, mg/L | 140 ± 45 | 59 ± 20 | 58 | 124 ± 35 | 44 ± 18 | 65 | 152 ± 118 | 73 ± 57 | 52 |
| TP, mg/L | 5.9 ± 0.64 | 3.37 ± 0.23 | 43 | 6.51 ± 0.29 | 4.28 ± 0.8 | 34 | 6.85 ± 0.93 | 10.05 ± 2.7 | −47 |
| tDP, mg/L | 3.98 ± 0.63 | 2.23 ± 0.84 | 44 | 4.64 ± 0.55 | 3.21 ± 0.4 | 31 | 4.62 ± 0.64 | 7.78 ± 1.82 | −68 |
| tSP, mg/L | 1.93 ± 0.53 | 1.21 ± 0.72 | 37 | 1.87 ± 0.6 | 1.07 ± 0.73 | 43 | 2.23 ± 0.6 | 2.27 ± 1.65 | −2 |
| RP, mg/L | 4.94 ± 0.55 | 2.46 ± 0.94 | 50 | 4.99 ± 1.03 | 3.15 ± 1.12 | 37 | 4.43 ± 0.51 | 9.71 ± 0.42 | −119 |
| tCOD, mg/L | 385 ± 47 | 139 ± 35 | 64 | 985 ± 115 | 154 ± 31 | 84 | 406 ± 151 | 179 ± 63 | 56 |
| sCOD, mg/L | 182 ± 17 | 73 ± 24 | 60 | 166 ± 53 | 76 ± 37 | 54 | 151 ± 23 | 70 ± 16 | 54 |
| NH4—N, mg/L | 31 ± 3 | 42 ± 4 | −38 | 30 ± 7 | 37 ± 10 | −25 | 33 ± 6 | 43 ± 10 | −31 |

### Example 7: Sugar Beet Waste Storage Treatment

Sugar beet waste storage sometimes results in ambient H₂S concentration over 100 ppb around waste storage using Minnesota Pollution Control Agency compliant protocol. Several chemical methods to decrease H₂S concentration were tested. Sugar beet wastewater samples were collected from different sites, including sites A, B, and C on a sugar beet farm. Site A was a location with a combination of liquefied vapor, beet storage leachate, and processing wastewater. Site B was a location including over-flow lagoon for long-term storage. Site C was a location including effluent from an anaerobic digestion treatment facility

The experiment described herein used samples collected at sites A and B. Samples from site C were excluded as this wastewater was being treated for MPCA compliance. Collected wastes, before being treated, were analyzed for relevant water qualities with an emphasis on the amount of total sulfur, sulfate sulfur, and sulfide sulfur.

400 ml of wastewater samples were transferred into 500 ml polypropylene bottles with electrode inserted. For the mentioned volume of liquid, a proper electrode surface area was selected based on parameters from previous experiments. Anaerobic storage was allowed for the first 7 days: after that, for control groups, no voltage was applied, while for experimental groups, a voltage was applied to electrode terminals.

Relevant characteristics of the wastewater collected from site A and B are given in TABLE 10. The respective total sulfur contents were 18.8±1.4 mg/L and 63.6±9.5 mg/L based on Inductivly Coupled Plasma analysis. This suggests that the wastewater has a substantial potential to develop hydrogen sulfide emission issues during storage. When collected, sulfide contents in the reactor were about 0.9 mg/L and 0.8 mg/L, respectively. Assuming at 20° C., the calculated equilibrium H₂S concentration in the headspace were 26 and 221 ppm, respectively.

TABLE 10
Wastewater characteristics from two sources at sugar beet
processing company

| | Site A | Site B |
|---|---|---|
| pH | 7.93 | 4.59 |
| Conductivity ms/cm | 1.73 | 6.62 |
| Total sulfur, mg/L | 18.8 ± 1.4 | 63.6 ± 9.5 |
| Sulfide, mg/L | 0.9 | 0.8 |
| Calculated H₂S(g), ppm | 26 | 221 |
| COD, mg/L | 2937 | 23052 |

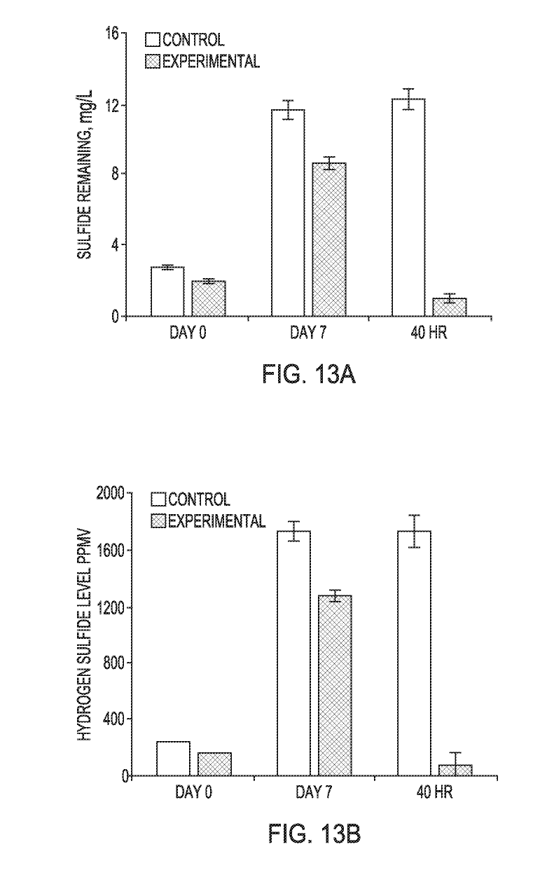

For the wastewater source site A, after anaerobic storage for seven (7) days, both the measured sulfide in the wastewater and the H₂S in the headspace gas increased significantly, as shown in FIGS. 13A and 13B. However, as is also shown in FIGS. 13A and 13B, once the electrochemical treatment was applied for 40 hours, both levels substantially dropped (sulfide in the wastewater from 12.0 mg/L to 1.0 mg/L, and H₂S in the headspace from 1736 ppm to 73 ppm, or about 96% removal efficiency). After another week of anaerobic storage of the electrochemically-treated sugar beet wastewater, the H₂S concentration remained the same without a substantial increase. For wastewater source from site B, after anaerobic storage for seven (7) days, there were no noticeable increase of either sulfide or H₂S level; therefore, no electrochemical treatment was applied to this water source.

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### ADDITIONAL EMBODIMENTS

The following exemplary embodiments are provided, the numbering of which is not to be construed as designating levels of importance:

Embodiment 1 provides a system comprising:

a housing

a chamber within the housing for receiving a working fluid comprising at least one of one or more sulfide species and one or more phosphorous species;

a first anode and a first cathode each at least partially disposed within the chamber, wherein at least one of the first anode and the first cathode are formed from at least one of: low carbon steel stainless steel, copper, plain carbon cloth, and one or more mixed metal oxides, and wherein at least a first one of the one or more sulfide species and the one or more phosphorous species is electrochemically converted at the first anode or the first cathode to at least one first reaction product that is removable from the working fluid; and

a separation apparatus to separate the at least one first reaction product from the working fluid to provide a purified working fluid.

Embodiment 2 provides the system of Embodiment 1, wherein the stainless steel comprises at least one of: AISI 304 stainless steel, AISI 316 stainless steel, AISI 430 stainless steel, or a combination thereof.

Embodiment 3 provides the system of either one of Embodiments 1 or 2, wherein the copper comprises C110 copper.

Embodiment 4 provides the system of any one of any one of Embodiments 1-3, wherein the first anode and the first cathode are formed from the same material.

Embodiment 5 provides the system of any one of Embodiments 1-4, wherein the first anode and the first cathode are formed from different materials.

Embodiment 6 provides the system of any one of Embodiments 1-5, wherein the first anode and the first cathode are adapted to receive a voltage.

Embodiment 7 provides the system of any one of Embodiments 1-6, wherein the voltage is from about 0.2 V to about 5 V.

Embodiment 8 provides the system of any one of Embodiments 1-7, further comprising a microbial biofilm disposed on an external surface of the first anode.

Embodiment 9 provides the system of any one of Embodiments 1-8, wherein the microbial biofilm is disposed over at least about 5% to about 100% of a surface area of the external surface of the first anode.

Embodiment 10 provides the system of any one of Embodiments 1-9, wherein the microbial biofilm is disposed over about at least about 10% to about 25% of a surface area of the external surface of the first anode.

Embodiment 11 provides the system of any one of Embodiments 1-10, further comprising:

a second anode; and

a second cathode,

wherein at least a second one of the one or more sulfide species and the one or more phosphorous species is electrochemically converted at the second anode or the second cathode to at least one second reaction product that is removable from the working fluid.

Embodiment 12 provides the system of any one of Embodiments 1-11, wherein the second anode and the second cathode are formed from the same material.

Embodiment 13 provides the system of any one of Embodiments 1-12, wherein the second anode and the second cathode are formed from different materials.

Embodiment 14 provides the system of any one of Embodiments 1-13, wherein the first anode and the second anode are formed from the same material.

Embodiment 15 provides the system of any one of Embodiments 1-14, wherein the first cathode and the second cathode are formed from the same material.

Embodiment 16 provides the system of any one of Embodiments 1-15, wherein the second anode further comprises a microbial biofilm disposed on an external surface of the second anode.

Embodiment 17 provides the system of any one of Embodiments 1-16, wherein the microbial biofilm is disposed over about 10% to about 100% of a surface area of the external surface of the second anode.

Embodiment 18 provides the system of any one of Embodiments 1-17, wherein the microbial biofilm is disposed over about 10% to about 25% of a surface area the external surface of the second anode.

Embodiment 19 provides the system of any one of Embodiments 1-18, and further comprising:

an electrolyte media having a conductivity of greater than or equal to about 1 mS/cm and disposed within the housing.

Embodiment 20 provides the system of any one of Embodiments 1-19, wherein the system comprises at least one of: a centralized sewage system, a subsurface sewage treatment system, an anaerobic digester system, and a biogas generation system.

Embodiment 21 provides the system of any one of Embodiments 1-20, wherein the system is an anaerobic digester system comprising at least one of: a continuously stirred tank reactor, a plug flow reactor, a batch reactor, a semi-batch reactor, an anaerobic sequencing batch reactor, an upflow anaerobic sludge blanket reactor, an anaerobic membrane bioreactor, an expanded granular sludge blanket reactor, or any combination thereof.

Embodiment 22 provides the system of any one of Embodiments 1-21, wherein the housing is at least partially disposed in a well, a tunnel, or an agricultural silo.

Embodiment 23 provides the system of any one of Embodiments 1-22, wherein the housing is at least partially located in an aqueous environment.

Embodiment 24 provides the system of any one of Embodiments 1-23, wherein the working fluid is in contact with at least one of the first anode and the first cathode.

Embodiment 25 provides the system of any one of Embodiments 1-24, wherein the working fluid comprises organic waste.

Embodiment 26 provides the system of any one of Embodiments 1-25, wherein the organic waste comprises at least one of: animal manure, wastewater treatment plant sludge, food processing wastewater, and municipal solid waste treatment plant organic fractions.

Embodiment 27 provides the system of any one of Embodiments 1-26, wherein the separation apparatus is a valve adapted to allow the purified working fluid to exit the chamber.

Embodiment 28 provides the system of any one of Embodiments 1-27, wherein the one or more sulfide species comprise at least one of: hydrogen sulfide, bisulfide, or sulfide.

Embodiment 29 provides the system of any one of Embodiments 1-28, wherein the one or more sulfide species is from about 0.5 mol % to about 10 mol % of the working fluid.

Embodiment 30 provides the system of any one of Embodiments 1-29, wherein the one or more sulfide species is from about 1 mol % to about 5 mol % of the organic waste.

Embodiment 31 provides the system of any one of Embodiments 1-30, wherein the one or more sulfide species is in an aqueous phase.

Embodiment 32 provides the system of any one of Embodiments 1-31, wherein the working fluid comprises biogas.

Embodiment 33 provides the system of any one of Embodiments 1-32, wherein the biogas is from about 0.5 mol % to about 10 mol % of the working fluid.

Embodiment 34 provides the system of any one of Embodiments 1-33, wherein the biogas is from about 1 mol % to about 5 mol % of the working fluid.

Embodiment 35 provides the system of any one of Embodiments 1-34, wherein the electrode assembly oxidizes the one or more sulfide species into a disulfide, polysulfide, elemental sulfur, polythiosulfite, thiosulfate, sulfite, sulfate, or a mixture thereof.

Embodiment 36 provides the system of any one of Embodiments 1-35, wherein the one or more phosphorous species is from about 0.5 mol % to about 10 mol % of the working fluid.

Embodiment 37 provides the system of any one of Embodiments 1-36, wherein the one or more phosphorous species is from about 1 mol % to about 5 mol % of the working fluid.

Embodiment 38 provides the system of any one of Embodiments 1-37, and further comprising a non-active electrode material at least partially disposed in the chamber.

Embodiment 39 provides the system of any one of Embodiments 1-38, wherein the non-active electrode material is at least one of tin oxide and lead oxide.

Embodiment 40 provides the system of any one of Embodiments 1-39, wherein the non-active electrode material is coated on a substrate.

Embodiment 41 provides the system of any one of Embodiments 1-40, wherein the substrate is formed from at least one of titanium and boron-doped diamond.

Embodiment 42 provides a method for removing at least one of one or more sulfide species or one or more phosphorous species from a working fluid comprising:

contacting the working fluid with at least one of a first anode and a first cathode;

applying a voltage across the first anode and the first cathode to electrically convert at least a first one of the one or more sulfide species and the one or more phosphorous species to a reaction product; and

separating the reaction product from the working fluid to provide a substantially purified working fluid.

Embodiment 43 provides the method of Embodiment 42, wherein the voltage is applied to the first anode and the first cathode for a time period ranging from about 4 hours to about 200 days.

Embodiment 44 provides the method of either one of Embodiments 42 or 43, wherein the voltage is applied to the first anode and the first cathode for a time period ranging from about 1 day to about 70 days.

Embodiment 45 provides the method of any one of Embodiments 42-44, wherein the voltage is applied to the first anode and the first cathode for a time period ranging from about 20 days to about 70 days.

46 provides the method of any one of Embodiments 42-45, further comprising maintaining a temperature of the working fluid at from about 15° C. to about 30° C.

Embodiment 47 provides the method of any one of Embodiments 42-46, further comprising maintaining a temperature of the working fluid at from about 15° C. to about 25° C.

Embodiment 48 provides the method of any one of Embodiments 42-47, further comprising adding at least one of a ferrous compound and a ferric compound to the working fluid.

Embodiment 49 provides the method of any one of Embodiments 42-48, wherein a concentration of the at least one of the ferrous compound and the ferric compound in the working fluid ranges from about 0.5 mM to about 2 mM.

Embodiment 50 provides the method of any one of Embodiments 42-49, wherein from about 70 wt % to about 99 wt % of the one or more phosphorous species is removed from the working fluid after the voltage is applied.

Embodiment 51 provides the method of any one of Embodiments 42-50, wherein from about 70 wt % to about 99 wt % of the one or more sulfide species is removed from the working fluid after the voltage is applied.

Embodiment 52 provides the method of any one of Embodiments 42-51, wherein an amount of energy consumed by applying the voltage to remove at least one of the one or more sulfide species and the one or more phosphorous species ranges from about 0.2 kWh/m³ of the working fluid to about 40 kWh/m³ of the working fluid.

Embodiment 53 provides the method of any one of Embodiments 42-52, wherein the method does not include a pre-concentrating step.

Embodiment 54 provides the method of any one of Embodiments 42-53, wherein the sulfide species in not removed in a gaseous phase.

What is claimed is:

1. A system comprising:
a housing
a chamber within the housing for receiving a working fluid comprising at least one of one or more sulfide species or one or more phosphorous species;
a first anode and a first cathode each at least partially disposed within the chamber, wherein at least one of the first anode and the first cathode are formed from at least one of: low carbon steel, stainless steel, copper, plain carbon cloth, and one or more mixed metal oxides, and wherein at least a first one of the one or more sulfide species or the one or more phosphorous species is electrochemically converted at the first anode or the first cathode to at least one first reaction product that is removable from the working fluid; and
a separation apparatus to separate the at least one first reaction product from the working fluid to provide a purified working fluid.

2. The system of claim 1, wherein the stainless steel comprises at least one of: AISI 304 stainless steel, AISI 316 stainless steel, AISI 430 stainless steel, or a combination thereof.

3. The system of claim 1, wherein the copper comprises C110 copper.

4. The system of claim 1, wherein the first anode and the first cathode are formed from the same material.

5. The system of claim 1, wherein a voltage of from about 0.2 V to about 5 V is applied to the first anode and the first cathode.

6. The system of claim 1, further comprising:
a second anode; and
a second cathode,
wherein at least a second one of the one or more sulfide species or the one or more phosphorous species is electrochemically converted at the second anode or the second cathode to at least one second reaction product that is removable from the working fluid; and
wherein the separation apparatus separates the at least one second reaction product from the working fluid to provide the purified working fluid.

7. The system of claim 1, wherein the second anode and the second cathode are formed from the same material.

8. The system of claim 1, and further comprising an electrolyte media having a conductivity of greater than or equal to about 1 mS/cm and disposed within the housing at least partially between the first anode and the first cathode.

9. The system of claim 1, wherein the system comprises at least one of: a centralized sewage system, a subsurface sewage treatment system, an anaerobic digester system, and a biogas generation system.

10. The system of claim 1, wherein the working fluid comprises organic waste.

11. The system of claim 10, wherein the organic waste comprises at least one of: animal manure, wastewater treatment plant sludge, food processing wastewater, and municipal solid waste treatment plant organic fractions.

12. The system of claim 1, wherein the electrode assembly oxidizes the one or more sulfide species into a disulfide compound, a polysulfide compound, elemental sulfur, a polythiosulfite compound, a thiosulfate compound, a sulfite compound, a sulfate compound, or a mixture thereof.

13. A method comprising:
contacting a working fluid with at least one of a first anode and a first cathode, wherein the working fluid comprises at least one of: one or more sulfide species or one or more phosphorous species;
applying a voltage across the first anode and the first cathode while contacting the working fluid with the at least one of the first anode and the first cathode to electrically convert at least a first one of the one or more sulfide species and the one or more phosphorous species to a reaction product; and
separating the reaction product from the working fluid to provide a purified working fluid.

14. The method of claim 13, wherein the voltage is applied to the first anode and the first cathode for a time period ranging from about 4 hours to about 200 days.

15. The method of claim 13, further comprising adding at least one of a ferrous compound and a ferric compound to the working fluid.

16. The method of claim 15, wherein a concentration of the at least one of the ferrous compound and the ferric compound in the working fluid ranges from about 0.5 mM to about 2 mM.

17. The method of claim 13, wherein from about 70 wt % to about 99 wt % of the one or more phosphorous species is removed from the working fluid after the voltage is applied.

18. The method of claim 13, wherein from about 70 wt % to about 99 wt % of the one or more sulfide species is removed from the working fluid after the voltage is applied.

19. The method of claim 13, wherein the method does not include a pre-concentrating step.

20. The method of claim 13, wherein the sulfide species in not removed in a gaseous phase.
